(19) United States
(12) Patent Application Publication
(10) Pub. No.: US 2019/0378180 A1
(43) Pub. Date: Dec. 12, 2019

(54) METHOD AND SYSTEM FOR GENERATING AND USING VEHICLE PRICING MODELS

(71) Applicant: NthGen Software Inc., Toronto (CA)

(72) Inventors: Mark Endras, Vaughan (CA); Nataliya Portman, North York (CA); Akbar Nurlybayev, Toronto (CA); Ahad Beykaei, Toronto (CA)

(73) Assignee: NthGen Software Inc., Toronto (CA)

(21) Appl. No.: 16/362,807

(22) Filed: Mar. 25, 2019

Related U.S. Application Data
(60) Provisional application No. 62/647,494, filed on Mar. 23, 2018.

(51) Int. Cl. G06Q 30/02; G06N 20/00

(52) U.S. Cl. CPC G06Q 30/0283; G06N 20/00

(57) ABSTRACT

A system and method for generating an using vehicle price estimation models is disclosed. The price estimation models may be segmented in several ways including based on: (1) make/model; (2) make/model and another feature (such as trim); or (3) clustering of data. For example, a baseline model (to make/model or make/model/trim) may be generated using historical pricing data. Further, the historical pricing data may be clustered in order to generate multiple price bins. Additional models may be generated to the multiple price bins. In practice, an initial price estimate for the vehicle may be generated using the baseline model. Thereafter, using the initial price estimate, one of the price bin models (whose price bin includes the initial price estimate) may be used to generate a price bin estimate. The initial price estimate and/or the price in estimate may then be used for the auction (such as a guaranteed auction price).

### REFERENCE TO RELATED APPLICATION

This application claims the benefit of U.S. Provisional Patent Application Ser. No. 62/647,494 filed on Mar. 23, 2018, the entirety of which is hereby incorporated herein.

### BACKGROUND

When selling a vehicle, the price estimate of a vehicle may be obtained. The price may be determined based on reviewing previous sale prices of similar vehicles.

### DESCRIPTION OF THE FIGURES

FIG. 1A illustrates a first exemplary system for training and using a vehicle predictive pricing model.

FIG. 1B illustrates a first exemplary system for training and using a vehicle predictive pricing model.

FIG. 1C illustrates a second exemplary system for training and using a vehicle predictive pricing model.

FIG. 1D illustrates the second exemplary system (in more detail) for training and using a vehicle predictive pricing model.

FIG. 2 illustrates a block diagram of exemplary computer architecture for a device in the exemplary system of FIGS. 1A-D.

FIG. 3A illustrates an exemplary flow diagram of logic to generate a predictive pricing model.

FIG. 3B illustrates a chart of feature selection for different makes/models.

FIG. 4 illustrates a block diagram for a methodology to build accurate predictive pricing models.

FIG. 5 illustrates a block diagram for an algorithm structure to generate and use a predictive pricing model.

FIG. 6 illustrates an exemplary flow diagram for vehicle valuation using one or more predictive pricing models.

FIG. 7A illustrates a histogram of the probability to 1 for the most popular price of a respective vehicle.

FIGS. 7B-D illustrate the results of the simulation to determine the expected profit for three different fees (FIG. 7B, $120; FIG. 7C, $320; FIG. 7D, $600), K=151, N=10.

FIG. 8 illustrates a graph of the sample of price_bin (clusters) for the make/model of “Ford-F-150” generated from the system with price along the x-axis and number of vehicle sold along the y-axis.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

Various types of goods may be sold, such as vehicles (e.g., cars, trucks, boats, or the like). In selling the vehicles, a seller may wish to obtain pricing information. Pricing information may take one of several forms, and may be used in one of several contexts. In one form, the pricing information may be directed to a current value (or a current range of values) of the vehicle. In one context, the current value (or the current range of values) may be used in order to determine an initial bid (e.g., a suggested opening bid) for an auction or other type of sale of the vehicle. In another form, the pricing information may be directed to a future value (or future range of values) of the vehicle. In another context, the future value (or the future range of values) may be used in order to determine whether (and/or how) to sell a vehicle at a future time. Thus, though the discussion below focuses on using the predictive pricing model for determining a minimum bid (such as a minimum opening bid) for an auction, the predictive pricing model may be used in any context in which an assessed value of the vehicle (whether currently or at a predetermined future time) is sought.

Market value of a used vehicle may be defined as the amount of money a bidder is willing to pay and a seller is willing to accept. Thus, the market value, in one definition, is the price of a vehicle in the “won” trade state. Given this, data regarding the “won” trades is plentiful. However, organizing the data into reliable and accurate predictive models is difficult.

In one implementation, a system is disclosed for assisting in at least one aspect of the sale (such as the auction) of an item (e.g., a vehicle). The system includes a general purpose pricing system, which may include one (or multiple) price estimation models (such as functionality to generate one or more machine-learning price estimation models).

The pricing system may be used for different functions associated with the auction process. For example, functions reliant on machine-learning (ML)-based pricing estimation models may include any one, any combination, or all of:

valuation of the vehicle: used as a tool for a sales team;

bid assist: suggested initial bid;

maximum bid for an auction: Guaranteed Auction Price (GAP): what the seller may be guaranteed to receive regardless of the outcome of the auction; and

suggested price in the event that the reserve is not met during auction: in the event that the highest bid during the auction does not meet the reserve, one or both of the seller or one of the bidders (such as the highest bidder in the auction) may be offered a suggested price to sell or buy the vehicle.

The price estimation model may include one or more inputs (such as one or more features, including make/model, mileage, age, etc., of the vehicle subject to auction) and may generate one or more outputs, such as an estimated price of the vehicle. In one implementation, the pricing system includes one or more techniques for generating a price estimation model.

Price estimation models may be segmented in any one, any combination, or all of the following ways including: (1) based on make/model; (2) based on make/model and another feature (such as trim); or (3) based on clustering of data. As discussed in further detail below, different price estimation models may be generated for different makes/models. For example, a first price estimation model may be generated for a Toyota Corolla and a second price estimation model may be generated for a Toyota Camry. Alternatively, different price estimation models may be generated for different makes/models/trims. For example, the Toyota RAV4 comes in three trims: LE; XLE; and Limited. Different price estimation models may be generated for Toyota RAV4 LE; Toyota RAV4 XLE, and Toyota RAV4 Limited.

Data may be used in order to generate the respective model. For example, for the Toyota RAV4 price estimation model, pricing data for Toyota RAV4 may be used. As another example, for the Toyota RAV4/XLE price estimation model, pricing data for Toyota RAV4/XLE may be used. In one implementation, all of the pricing data (except optionally data removed due to outliers or cleaning) may be used to generate the respective price estimation model.

In still an alternate implementation, pricing data for a respective make/model or make/model/trim may be analyzed for density and/or distribution of data in order to perform clustering (such as generating a first cluster for a first price range, a second cluster for a second price range, etc.). Further, data cleaning and outlier detection may be performed before or after clustering, as discussed below. Based on the clustering, price bins may be assigned to the different clusters (e.g., a first price bin may be assigned to the first cluster (with the first price range); a second price bin may be assigned to the second cluster (with the second price range); etc.). Responsive to assigning the price bins, price estimation models may be generated for one, some, or all of the assigned price bins. For example, a first price estimation model (for the respective make/model in the first price bin) may be generated, a second price estimation model (for the respective make/model in the second price bin) may be generated, and so on.

As discussed further below, the historical pricing data used to generate the respective price estimation models may be a subset of the entire data set available. For example, for a make/model/price bin (such price_bin_XtoY with a price range from $X to $Y), the historical pricing data used may be a subset of all of the pricing data available. In particular, the historical pricing data may be related to the price range for the respective price bin. In the example of price_bin_XtoY associated with the price range from $X to $Y, the historical pricing data selected may be somehow related to the pricing range from $X to $Y, such as historical pricing data that is only within the range of $X to $Y, or historical pricing data that is within a predetermined amount within the outer bounds of $X and $Y (e.g., within 25% of the lower bound of $X and within 25% of the upper bound of $Y so that there is overlap of the edges of the price range for better coverage at the edges of the price range).

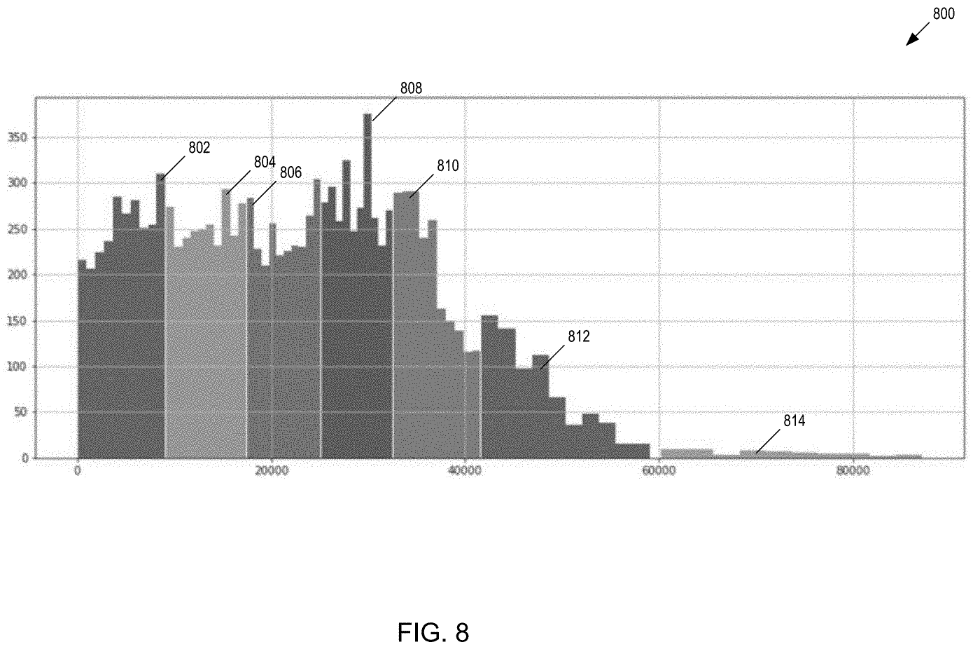

An example of clustering is illustrated in FIG. 8. In particular, FIG. 8 illustrate 7 separate clusters for the Ford F-150. In one embodiment, a price estimation model may be generated for each of the 7 clusters (e.g., Ford F-150 cluster 1; Ford F-150 cluster 2; Ford F-150 cluster 3; etc.). In particular, FIG. 8 depicts different clusters corresponding to different price bins including: cluster 1: price range of $0-$9K (e.g., lower price limit and upper price limit for price bin 1); cluster 2: price range of $9-$18K; cluster 3: price range of $18-$24K; cluster 4: price range of $24-$32K; cluster 5: price range of $32-$42K; cluster 6: price range of $42-$58K; and cluster 7: price range of $58-$90K. As discussed further below, based on the different clusters (or price bins), price bin models may be generated. With regard to the example graph 800 in FIG. 8, the following price estimation models may be generated: a first Ford F-150 price estimation model based only on data 802 (or based only on data 802 and part of data from 804) (with a corresponding price range of $0-$9K); a second Ford F-150 price estimation model based only on data 804 (or based only on data 804 and part of data from 802 and 806) (price range of $9-$18K); a third Ford F-150 price estimation model based only on data 806 (or based only on data 806 and part of data from 804 and 808) (price range of $18-$24K); a fourth Ford F-150 price estimation model based only on data 808 (or based only on data 808 and part of data from 806 and 810) (price range of $24-$32K); a fifth Ford F-150 price estimation model based only on data 810 (or based only on data 810 and part of data from 808 and 812) (price range of $32-$42K); a sixth Ford F-150 price estimation model based only on data 812 (or based only on data 812 and part of data from 810 and 814)(about $42-$58K); and a seventh Ford F-150 price estimation model based only on data 814 (or based only on data 814 and part of data from 812) (price range of $58-$90K). As discussed further below, based on the output of the baseline model, a price_bin model may be selected. In the example of FIG. 8, responsive to the baseline model outputting a price of $35K, the fifth Ford F-150 price estimation model may be used to generate a price estimation output. Continuing with the example, if the fifth Ford F-150 price estimation model generates an output of $37K, one or both of the output of the baseline model (e.g., $35K) or the output of the fifth Ford F-150 price estimation model (e.g., $37K) may be used for the price estimate. In the example of GAP, the lesser of the two outputs may be selected (in the given example, $35K is used as the estimate).

Another example of clustering may include the Toyota RAV4 LE; Toyota RAV4 XLE, and Toyota RAV4 Limited. The different trims may have different densities/data distributions. In that regard, the clustering for the different trims may be different including one or both of: the number of clusters, the number of historical data entries (e.g., entries representative of sales) within a respective cluster, or the price range for a respective cluster. In particular, lower end trims typically have less spread in the historical data entries, potentially resulting in a smaller number of clusters being selected based on the analysis of the density/distribution of the pricing data. For example, the number of clusters selected by the system for the Toyota RAV4 LE may be less than the number of clusters selected for the Toyota RAV4 Limited due to the data for the Toyota RAV4 LE (which is a lower-end trim) being clustered more together (e.g., 2 clusters for the Toyota RAV4 LE versus 5 clusters for the Toyota RAV4 Limited). In this example, price estimation models may be created as follows: Toyota RAV4 LE cluster 1 (e.g., machine learning to determine one or more important features based on analysis of the data in cluster 1); Toyota RAV4 LE cluster 2; Toyota RAV4 Limited cluster 1; Toyota RAV4 Limited cluster 2; Toyota RAV4 Limited cluster 3; Toyota RAV4 Limited cluster 4; and Toyota RAV4 Limited cluster 5. Thus, machine learning may find the relationship between one or more features of the vehicle (such as the relationship between age and mileage of the vehicle). Further, the machine learning may be focused generally on a make/model, a make/model/trim, and/or a make/model/trim/price_bin.

Clustering and/or generation of the price bin estimation model(s) may be performed prior to or after the baseline price estimation model generates the initial price estimate. As one example, response to the baseline price estimation model generates the initial price estimate, the system may cluster the data to determine the price bin(s), determine the specific price bin in which the initial price estimate resides, and then generates the specific price bin estimation model. As another example, the clustering of the data and generating the price bin estimation model(s) may be generated prior to the baseline price estimation model generates the initial price estimate.

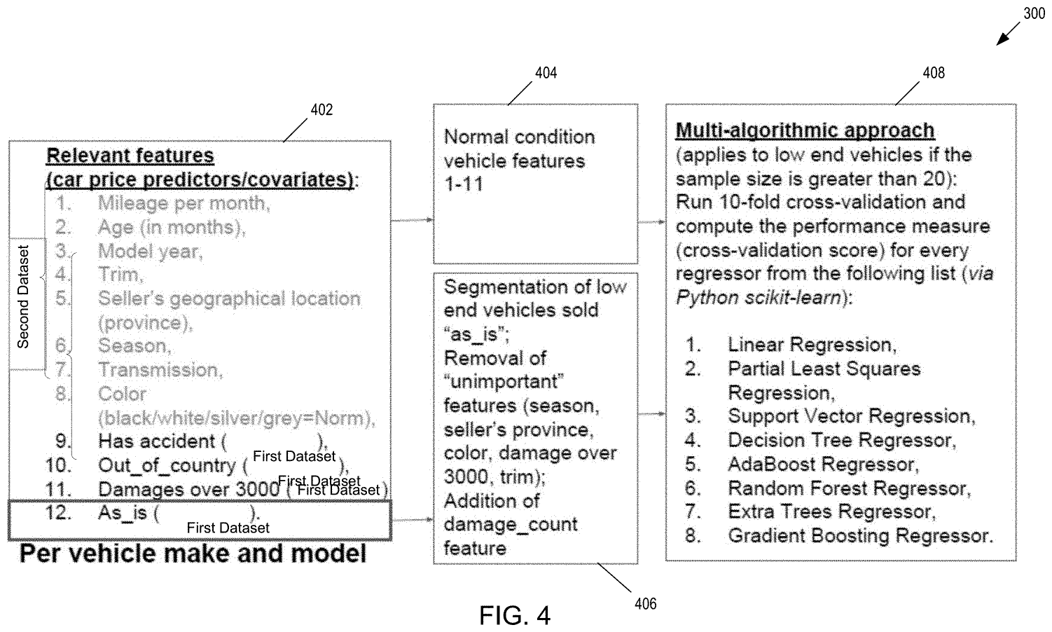

In this regard, segmentation of the vehicle price estimation models based on make/model or make/model/trim with clustering of the data for the respective make/model or make/model/trim may allow for the respective pricing estimation model to be more accurate or reliable (e.g., generating the price estimation model for the specific cluster of a make/model/trim improves the machine learning process, including identifying the features (see FIG. 4) that are used to build an accurate price estimation model).

Thus, the pricing system may include a plurality of price estimation models, as discussed above. The price estimation models generated may be based on machine-learning techniques or may be based on techniques that do not use machine learning. Three example techniques for generating a price estimation model comprise: (1) non-machine learning (ML) price estimation model; (2) vehicle valuation service (VVS); and (3) mini vehicle valuation service (MVVS). Any one, any combination, or all of (1), (2) and (3) are contemplated. Further, other price estimation models (such as other ML-based price estimation models) are contemplated in addition to, or instead of, those disclosed herein.

In one implementation, a non-ML price estimation model is contemplated in which some or all of the historical pricing data is examined and divided into buckets based on various factors, such as any one, any combination, or all of: age; model; mileage; trim; or model year. Thereafter, the data points in the respective buckets are examined for one or both of: minimum number of data points in the respective bucket; or to make estimates as to minimum, maximum and median price of the specific vehicle. In this regard, the non-ML price estimation model constrains the analysis to historical data in the respective buckets.

In another implementation, VVS may use machine learning based on make/model or make/model/specific price bin. As discussed further below, there are a plurality of features (e.g., year, condition, as-is, etc.) for a respective make/model. Machine learning may identify statistically important feature(s), particularly in situations where there is an insufficient amount of data in the respective buckets.

In still another implementation, MVVS may use machine learning based on make/model/trim or make/model/trim/specific price bin. Alternatively, or in addition, MVVS uses machine learning based on make/model/subvin or make/model/subvin/specific price bin. In either implementation, the part or all of the set of previous sales data (e.g., before Jun. 1, 2018) for that combination may be used to train the mini model. In a specific implementation, the features used comprise any one, any combination or all of: age, mileage and transmission.

In this regard, MVVS is similar to VVS except that at least one feature (such as trim) is preselected as statistically important prior to the machine learning analysis. In particular, instead of examining all of the available features for statistical importance, trim (and/or some other feature, such as mileage) is preselected and deemed statistically important. For example, VVS may segregate the previous sales data set based on Make and Model (MT) combinations. For each MT combination, the entire set of previous sales data (e.g., before Jun. 1, 2018) may thus be used to train the model. As discussed further below, there may be a set of features as input, with the machine learning algorithm selecting the most relevant feature(s) to build the model.

The machine learning may thus examine the data in the respective bucket (which may be clustered as well) in order to determine other statistically important features (selected from the remaining features available). In certain implementations, using MVVS (with at least one or multiple criteria being constrained/preselected) may improve the prediction of the respective MVVS-generated model versus using VVS and its respective VVS-generated model. Further, in one implementation, the MVVS-generated model is based on a linear regression model. Alternatively, the MVVS-generated model is based on a non-linear regression model. In still another implementation, the MVVS-generated model is based on both a linear and a non-linear regression model.

As discussed above, one or more price estimation models may be used in order to generate a price estimation. Further, as discussed above, the price estimations may be used for different aspects, such as, for example, valuation of the vehicle, bid assist, or the like. Further, in one implementation, multiple price estimation models may be used in order to generate the price estimation.

In a specific implementation, the output of a first price estimation model may be used in order to select a second price estimation model (e.g., the price estimation models may be used serially, with a first price estimation model, such as a baseline price estimation model, being used in order to select a second price estimation model, such as a price_bin price estimation model). For example, a Toyota RAV4 LE is subject to price estimation. Initially, a baseline price estimation model (which may be trained using the entire pricing dataset) for the Toyota RAV4 (in the example of VVS) or for the Toyota RAV4 LE (in the example of MVVS) may be used to generate an initial price estimation output. The initial price estimation output may then be used to select one of the Toyota RAV4 (or Toyota RAV4 LE) price bin models for further price estimation. By way of specific example, a 2012 Toyota RAV4 LE with 80,000 miles and a certain condition report is subject to valuation. Using the baseline model (either for the Toyota RAV4 or the Toyota RAV4 LE) and the features for the 2012 Toyota RAV4 LE, the baseline model outputs an initial value of $10,000. Using a look-up table or the like (e.g., a model for price-bin encoder which determines the range of the respective price-bins), the system may determine which price bin the initial value is within (e.g., for the Toyota RAV4 LE, the price bins are: $0-$5,000: price_bin 1; $5,001-$8,000: price_bin 2; $8,001-$11,000: price_bin 3: etc.). Thus, the system determines that the initial value of $10,000 is within bin 3, and selects the price estimation model for Toyota RAV4 LE price_bin 3. The features (e.g., age, mileage, condition, etc.) for the 2012 Toyota RAV4 LE are input to the selected the price estimation model for Toyota RAV4 LE price_bin 3, with the price estimation model for Toyota RAV4 LE bin 3 outputting a price_bin value (e.g., $11,125).

One or both of the initial value (generated by the baseline price estimation model) or the price_bin value (generated by the price_bin price estimation model) may be used to generate the determined value for the vehicle subject to valuation. In one implementation, only the initial value from the baseline price estimation model is used. For example, if the determined value is for the Guaranteed Auction Price and if the initial value output from the baseline price estimation model is less than the price_bin value from the price_bin price estimation model, the initial value is selected as the determined value for the vehicle in order to reduce the risk. In another implementation, only the price_bin value from the price_bin price estimation model is used. For example, if the determined value is for the Guaranteed Auction Price and if the initial value output from the baseline price estimation model is greater than the price_bin value from the price_bin price estimation model, the price_bin value is selected as the determined value for the vehicle in order to reduce the risk. In still another implementation, both the initial value and the price_bin value are used to generate the determined value of the vehicle. For example, an average (or a weighted average) of the initial value and the price_bin value may be used to generate the determined value of the vehicle. In this way, the output of one estimation model may be used in order to select another estimation model for further use.

Thus, in one implementation, a plurality of predictive price estimation models for a vehicle make/model are generated and used. For example, for a specific make/model, such as the Toyota Corolla, a plurality of predictive price estimation models, specific to the Toyota Corolla, are generated. The plurality of predictive price estimation models may be differentiated from one another in one of several ways, including based on any one, any combination, or all of the following aspects or features: type of sale (e.g., “As-is” or normal warranty associated auction); data used (whether the data used to generate a first predictive price estimation model is due to sales from a first company, whether the data used to generate a first predictive price estimation model is due to sales from a second company, or whether the data used to generate a first predictive price estimation model is due to sales from the first company and the second company); one or more aspects of use of the vehicle (such as a predictive price estimation model based on age and/or mileage of vehicle).

For example, the application may separate make/model data into “As_is” and regular vehicle data (e.g., normal warranty associated auction) in order to build low-end and regular vehicle price estimation models. Low-end vehicles may have a smaller size feature set, and when the vehicle reaches a certain age and mileage, then many regular car features such as options, disclosures, color and mileage stop playing a role (or play a lesser role) in the determination of its value. So, for each make/model, one may use a low vehicle subset and attempt to build an individual predictive price estimation model if the number of samples is at least a certain amount (e.g., 50). In this regard, the segmenting of the data to a subset focuses on the ultimate focus of the price estimation model (e.g., As-is sales) may reduce the amount of data for training the respective price estimation model and may further increase the reliability of the respective price estimation model.

Further, in one implementation, the plurality of predictive price estimation models may be generated based on one or more of the following steps including: feature determination; selection of methodology (e.g., machine learning methodology); outlier detection (e.g., removing outlier data); model training; and validation (e.g., validating the trained pricing model). The listed steps may be used for any of the price estimation models discussed herein (such as VVS, MVVS, whether a baseline model or a price_bin model). For example, with regard to feature determination, there may be a set of features associated with vehicle that are available for input to a price estimation model. In practice, for a respective predictive price estimation model (built for the make and model of the requested vehicle), the system determines a subset of the set of features that are important to the vehicle kind (normal or low-end). For example, a first price estimation model for a particular make/model may have a first subset of features and a second price estimation model for a particular make/model has a second subset of features, with the first subset of features being at least partly different than the second subset of features. Thus, in the example of the Toyota Corolla, the different price estimation models for the Toyota Corolla may have different subsets of features (e.g., inputs) to the respective price estimation models. In particular, a price estimation model for aged Toyota Corollas (e.g., >10 years old and/or >200,000 miles) may have a different set of inputs than a price estimation model for non-aged Toyota Corollas (e.g., <10 years old and/or <200,000 miles).

For example, a data-driven, potentially location-specific (e.g., data generated in Canada versus data generated in the United States), make/model based approach to building price estimation models is disclosed whereby a price is governed by a subset of features found to be statistically important (e.g., using feature importance algorithm) for make/model.

Determining whether a feature is statistically important may be determined in one of several ways. In one way, the determination focuses on whether there is a correlation between true and predicted values. For example, for a set of features, the focus may be directed to measuring the “strength” of a feature, such as how much (or to what extent) does the feature affect prediction accuracy. The correlation may be in a predefined range, such as from −1 to 1 (e.g., the correlation coefficient may vary between −1 and 1). In this regard, the focus may be to determine the correlation between true and predicted for a specific feature. Feature(s) are selected that have high correlation with the predictive value (between 0 to 1). Conversely, features that have negative correlation (from −1 to 0) may be rejected as these features have little or no influence on vehicle value. In this way, the features used for the price estimation model may be statistically meaningful and relevant to the vehicle price (e.g., the features may be indicative of predictive factors).

In this way, different price estimation models may be created based on vehicle sales records coming from different data sources. For example, one price estimation model may be generated if only data from a first company is used (e.g., TradeRev data), whereas another price estimation model (for the same specific make/model) is generated if using data from the first company and a second company (e.g., ADESA data). Thus, the price estimation models may be based only on “features” that statistically matter, with the statistically irrelevant or error-prone features being rejected. After which, a machine learning methodology may be used to train the price estimation model on the observations of these features.

Further, with regard to selection of the machine learning methodology, the system may determine, for the respective price estimation model, the machine learning methodology, which is selected from a set of potential machine learning methodologies. For example, a plurality of machine learning methodologies may be available for use. Depending on analysis of the different machine learning methodologies, a first machine learning method may produce a first price estimation model (e.g., a first price estimation model for the Toyota Corolla) and a second machine learning method may produce a second price estimation model (e.g., a second price estimation model for the Toyota Corolla). In this way, price estimation models directed to the same make/model, may vary considerably in regard to their performance. Therefore, the strategy is to select the best performing predictive model. Price estimation models for different make and models built in this way may vary in the important features used, such as based on the machine learning methodology used, the results of the outlier detection, and the like.

With regard to outlier detection, after the features are selected, the methodology may examine the data available in order to perform outlier detection. For example, there may be a rare vehicle record in the training dataset located far away from the bulk of the data (e.g., an outlier). If outliers are present, they may affect the accuracy of prediction. In this case, this record may be identified by a statistical method and removed prior to training the predictive pricing model.

Because of different data behavior, the representation of different price estimation models may vary, even though the different price estimation models are directed to the same make/model of vehicle (normal versus low-end data subsets). For example, the different price estimation models for the Toyota Corolla may be equation based, decision-tree based, or other types.

Specifically, the best performing algorithm may be used for the creation of price estimation model for Toyota Corolla. It may be, for example, a linear regression algorithm if the output (e.g., sold vehicle price) is indicative of being linearly dependent on important features of this vehicle. Furthermore, time-dependency aspect of sales records data may be exploited for the purpose of future forecast of the vehicle residual value. For example, the training dataset may be reframed into time-series dataset, and a multivariate time-series Recurrent Neural Network model can be used to learn time dependency patterns of the residual value as a function of time and vehicle features. Such a time series data-based model may yield predictions of residual values over a period of time that are of interest to a user (for example, it can be a one year period expressed in months). Then, the output may be a residual value curve that comprises (or consists of) 12 predicted residual values connected to form a curve. Then, the rate of change calculated from the predicted residual value curve may be indicative to a user as to how quickly this particular vehicle will depreciate over the chosen period of time.

Thus, in a first specific implementation, the price estimation models may be tailored to specifics heretofore unavailable (depending on the data source used to build a predictive model, certain feature observations may not be available). In a second specific implementation, the price estimation model for a specific make/model may be tailored to any one, any combination or all of: disclosures specific to the vehicle (e.g., repairs necessary (e.g., based on a vehicle history report and/or an inspection report), such as replacement of tires is necessary); options of the vehicle (air conditioning, sunroof, navigation, etc.); and history of accidents for the vehicle. Further, the price estimation model for a specific make/model may be tailored to a certain range of prices (e.g., a certain price_bin).

Alternatively, or in addition, another functionality built into the predictive pricing model is evaluation of price intervals that relies on 2D interpolating surfaces. There is no existing practical method to deduce confidence intervals for random forests regressor, since there is no formula, unlike the case with linear regression. However, random forests regressor may be desirable for the majority of makes/models. Because it is a stochastic method, if one repeatedly calls the algorithm for forecasting of the price of the same vehicle, it will yield slightly different price predictions. In this regard, in the abstract, using the random forests regressor is not feasible. However, creating an alternative method that returns the price interval may be based on the usage of 2D interpolating surfaces that are tabulated/discrete functions of mileage and age (e.g., expressed in months from January 01 of the model year to the date of vehicle sale). They are learned from training data that underlie the price estimation model. Various datapoints of the vehicles, such as mileage and age of the auctioned vehicle, may become known at the beginning of the active state of trade (e.g., BidAssist, discussed further below, may be automatically enabled once the vehicle is launched into auction and may include various relevant information, such as mileage and age of the auctioned vehicle). The lower and upper price bounds may be determined by interpolating 2D surfaces in a neighborhood of the mileage and age of the auctioned vehicle. For instance, if the forecasted price is above the mean price, then the lower bound may be computed as the mean price minus mean residual, and the upper bound may become the forecasted price. Thus, when BidAssist is activated, the opening minimum bid in an auction may be selected based thereupon, such as the opening minimum bid being determined as 50% of the lower price bound. This may be performed in an attempt to make forecasting intervals as narrow as possible. Without this adjustment, the price interval calculated as [forecasted price−mean residual, forecasted price+mean residual] may be too wide.

In a third specific implementation, the price estimation model may be trained for a discrete number of trim levels (e.g., build statistical meaningful price intervals per model year and trim level). This is an example of MVVS. Trim levels (or grades) may be different versions of the same model with different features and equipment. For models that use several trim choices, automakers usually offer three or four versions. For example, the 2013 Toyota RAV4 comes in three versions: LE; XLE; and Limited. In particular, a trim level similarity operation may be performed in order to determine a trim level nearest to a trim level of the vehicle subject to sale (e.g., in the event that there is a difference between the trim for the model and the trim for the vehicle subject to analysis). More specifically, incorporating the trim similarity concept into the calculation of the price range for the trim nearest to the trim of the auctioned vehicle in the event that the trim of the auctioned vehicle is not available in the training dataset for its make/model. The determined trim level nearest the trim level of the vehicle may then be used to determine the price range of the vehicle (e.g., if the predicted price happens to fall outside of the interval boundaries (e.g., by at least 30%), then the statistical price range along with its median is returned). Or, in the event that the predictive pricing model has a lower accuracy than a predetermined amount, the price range generated may correspond to the model year and trim of the auctioned vehicle or the price range of nearest model year and the trim or nearest trim in case when model year or trim are unavailable in the training dataset.

In practice, default price ranges may be calculated using one or more data sets (e.g., data from TradeRev and/or ADESA) in order to build statistically meaningful price intervals per model year and trim (e.g., reliable lower and upper bounds and the median of price distribution as a single price forecast). Vehicle prices generally do depend on their trims at large. In this way, the trim similarity concept may be incorporated into the calculation of the price range for the trim nearest to the one of the auctioned vehicle (in case the specific trim of the auctioned vehicle is not available in the training dataset for its make/model). Knowledge of price ranges may be particularly important since one can control whether the predictive model yields an unreasonably high or low price estimate in the “predictor” class. Indeed, if the predicted price happens to fall outside of the interval boundaries (e.g., by at least 30%), then the statistical price range along with its median is returned. The same strategy may be applied when there is no available predictive model to yield accurate predictions. This may be the case with low-end vehicles. When an “As_is” vehicle is being auctioned, usually for less popular makes/models, there is little to no possibility to build an accurate pricing model that performs at least at 85% of accuracy. In this case, the methodology may return the price range that corresponds to the model year and trim of the auctioned vehicle or the price range of nearest model year and the trim or nearest trim in case when model year or trim are unavailable in the training dataset.

In a fourth specific implementation, the price estimation model may be based on make/model in which at least one of the features of the predictive pricing model is MSRP (manufacturer's suggested retail price). The price estimation model, using the MSRP as a feature input, may be used to generate current price information for the vehicle (e.g., calculation of the residual value of a vehicle, that is defined as 100%*(maximal bidding price)/MSRP_high)) or may be used to generate future price information for the vehicle (e.g., forecasting of the residual value of a vehicle over a period of time in the future (with the duration being defined by a user)).

Thus, the price estimation models may be used in a variety of contexts. For example, valuation (and recommendation) services may be significantly used for appraisal of a used car. This valuation service increases work efficiency when it comes to prioritizing whom to contact personally about resolving situations with trades that ended up in pending states. In particular, sales team members may immediately see if a seller wants too much money for a vehicle. Faced with a seller that is, for example, $1,000.00 or $2,000.00 off the forecasted price, one may negotiate the price with the seller so that the seller has realistic expectations and eventually sells the vehicle.

The price estimation model may further be applied to a company acting as a vehicle sales assistant that would use the estimated vehicle value as the price that it guarantees (e.g., a guaranteed auction price (GAP), discussed further below) to sell the vehicle for through its sales system. Otherwise, the company would pay losses if the vehicle were to be sold for a lesser price. The price estimation model may thus be used as the basis for a guarantee on price. Forecasting of the vehicle residual value in the future (such as based on the vehicle's history and other factors influencing its value (e.g., history of accidents, mileage, geographical location, season, etc.)) may provide its owner with important information when it is best to sell the vehicle. For example, one time interval comprises a month time unit, with the calculation of a depreciation curve over a certain number of months in the future. The rate of the residual value decrease may be derived from this curve and may indicate when to expect a drop in the vehicle's value.

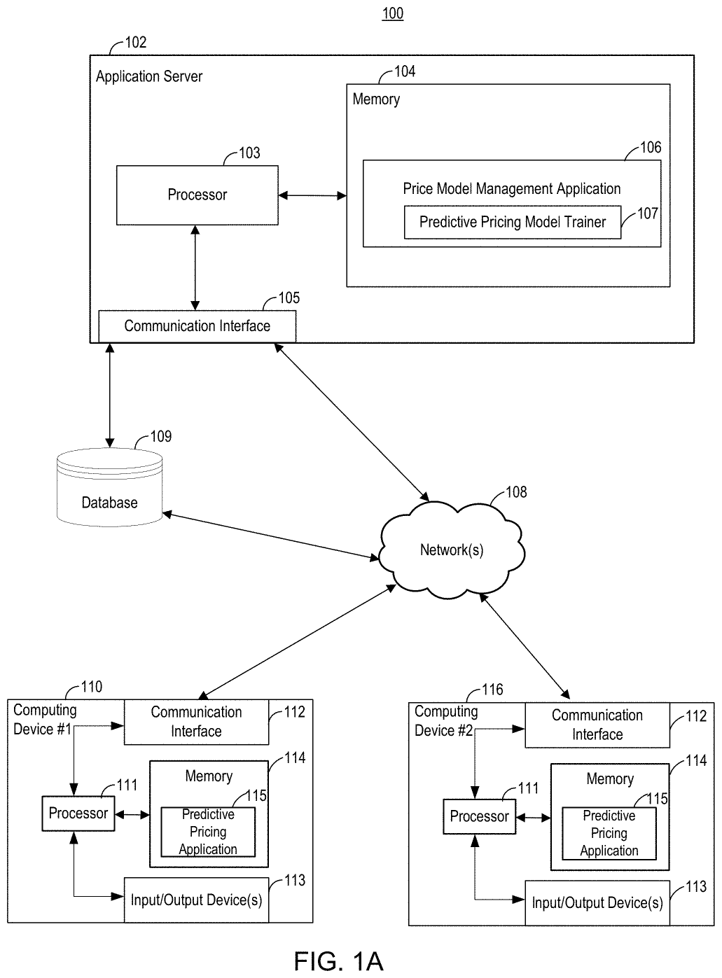

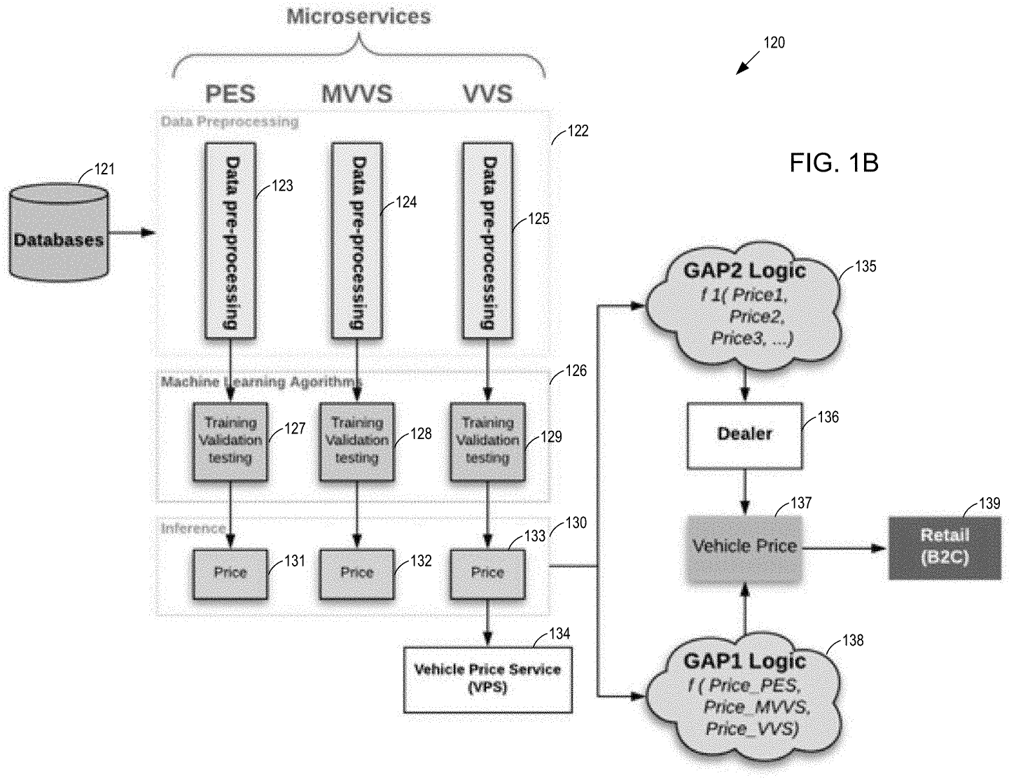

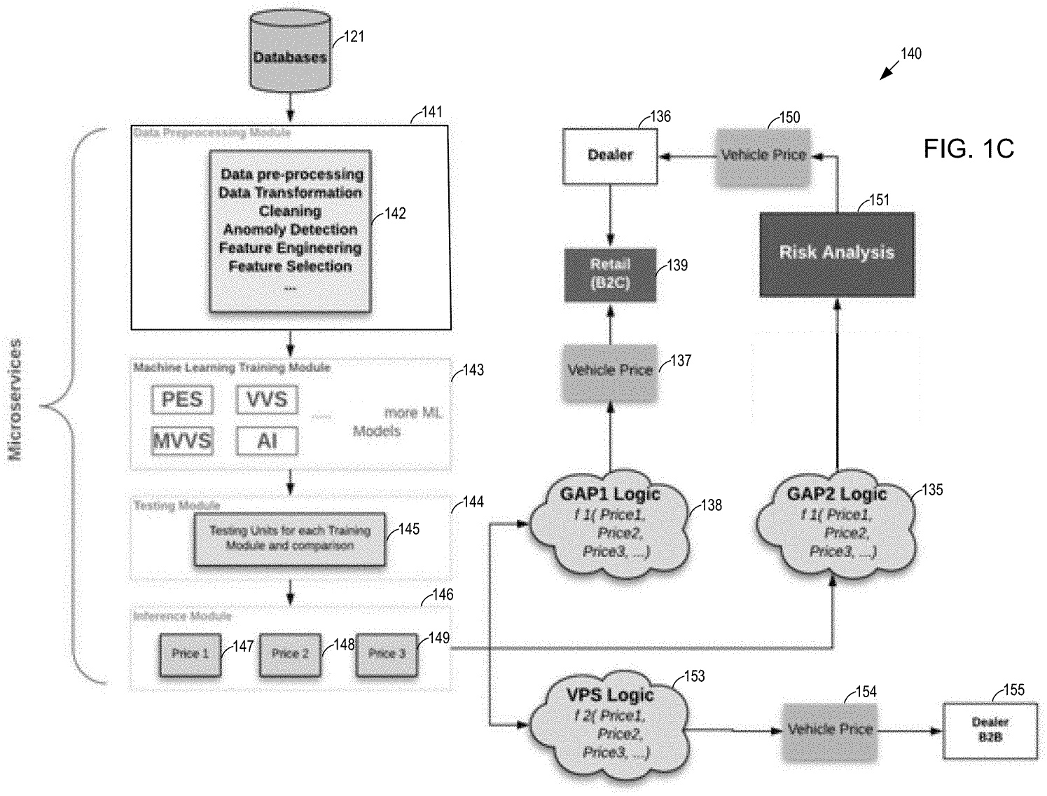

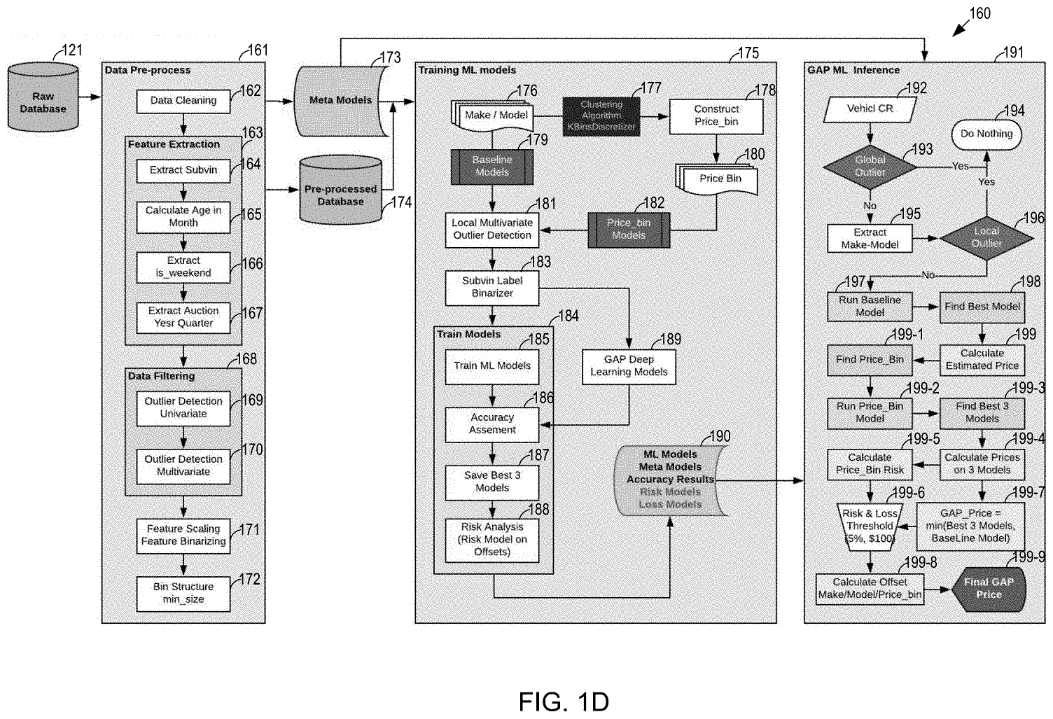

Referring to the figures, FIG. 1A illustrates an exemplary system 100 for training and using a vehicle predictive pricing model. The system 100 includes an application server 102 configured to include the hardware, software, firmware, and/or middleware for operating the Price Model management application 106. Application server 102 is shown to include a processor 103, a memory 104, and a communication interface 105. The Price Model management application 106 is described in terms of functionality to manage various stages of managing the predictive price model trainer 107.

Price Model management application 106 may be a representation of software, hardware, firmware, and/or middleware configured to implement the management of any one, any combination, or all of the stages of the predictive price model trainer 107. As discussed above, predictive price model trainer 107 is configured to train a plurality of price estimation models for a specific make/model. Predictive price model trainer 107 may be a representation of software, hardware, firmware, and/or middleware configured to implement respective features of the Price Model management application 106.

The system 100 may further include a database 109 for storing data for use by the Price Model management application 106. For example, data directed to sales of vehicles from one or more companies used by predictive price model trainer 107 may be stored in database 109.

The application server 102 may communicate with the database 109 directly to access the data. Alternatively, the application server 102 may also communicate with the database 109 via network 108 (e.g., the Internet). Though FIG. 1A illustrates direct and indirect communication, in one implementation, only direct communication is used, in an alternate implementation, only indirect communication is used, and still in an alternate implementation, both direct and indirect communication is used.

The application server 102 may communicate with any number and type of communication devices via network 108. For example, application server 102 may communicate with electronic devices associated with one or more users. For example, FIG. 1A depicts two mobile devices, including computing device #1 (110) and computing device #2 (116). The depiction in FIG. 1A is merely for illustration purposes. Fewer or greater numbers of mobile devices are contemplated.

Computing device #1 (110) and computing device #2 (116) shown in FIG. 1A may include well known computing systems, environments, and/or configurations that may be suitable for implementing features of the predictive pricing application 115 such as, but are not limited to, smart phones, tablet computers, personal computers (PCs), server computers, handheld or laptop devices, multiprocessor systems, microprocessor-based systems, network PCs, or devices, and the like. FIG. 1A further shows that computing device #1 (110) and computing device #2 (116) include a processor 111, a memory 114 configured to store the instructions for operating predictive pricing application 115 (the functionality being discussed further below), input/output device(s) 113 (such as touch sensitive displays, keyboards, or the like), and a communication interface 112.

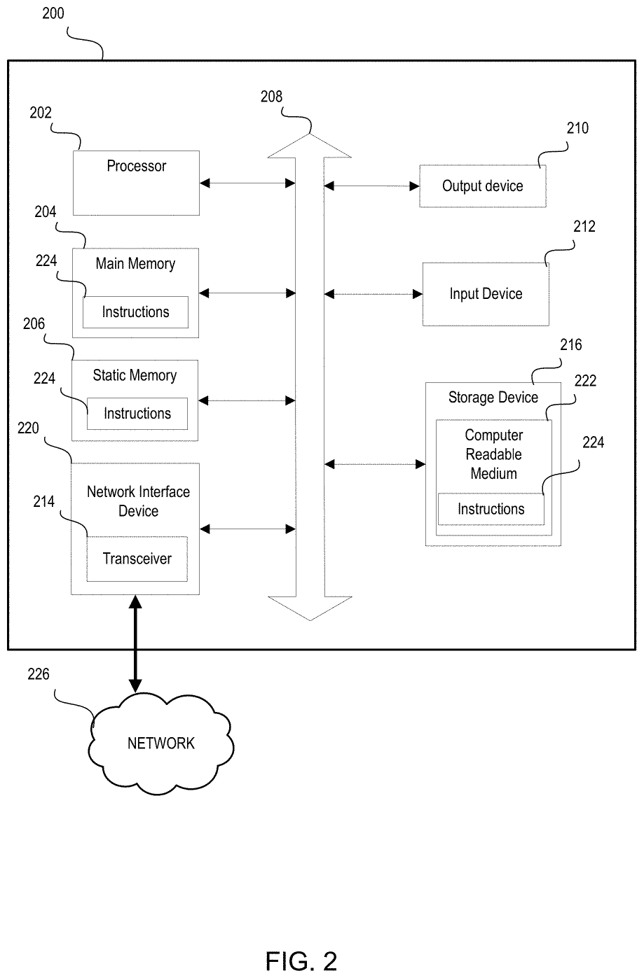

The various electronic devices depicted in FIG. 1A may be used in order to implement the functionality discussed herein. In this regard, each of computing device #1 (110), computing device #2 (116), application server 102, and database 109 may include one or more components of computer system 200 illustrated in FIG. 2.

FIG. 1B illustrates a first exemplary system 120 for training and using a vehicle predictive pricing model. The system 120 includes a plurality of microservices to generate different types of price estimation models, such as Price Estimation Model (PES) (not based on machine-learning), VVS, and MVVS. Each respective price estimation model methodology may access data from database 121 and perform respective data pre-processing 123, 124, 125 at a data pre-processing stage 122. After which, at a learning algorithm stage 126, respective steps of training, validation and testing 127, 128, 129 may be performed. An output, at an inference stage 130, may generate a respective predicted price 131, 132, 133. The respective predicted price 131, 132, 133 may be input to vehicle price service 134, which comprises a platform through which the respective predicted price 131, 132, 133 may be utilized.

In one implementation, the respective predicted price 131, 132, 133 may be used to generate a guaranteed auction price (GAP) or a range of a GAP. As illustrated in FIG. 1B, two GAPs may be generated including GAP1 and GAP2. GAP1 may comprise a range of prices and may be generated, using GAP1 logic 138, based on one, some, or all of the predicted price 131 (Price_PES), predicted price 132 (Price_MVVS), or predicted price 133 (Price_VVS). GAP2 may comprise a single value, indicative of one implementation of GAP, and may be generated by GAP2 logic 135. GAP2 may be input to dealer 136. Further, vehicle price 137 may be generated for output to a website, such as Retail (B2C) 139.

FIG. 10 illustrates a second exemplary system 140 for training and using a vehicle predictive pricing model. System 140 includes a data preprocessing module 141, that is configured to perform any one, any combination, or all of: data pre-processing; data transformation; cleaning; anomaly detection; feature engineering (e.g., combining different features (such as age/mileage) to create new features); or feature selection (e.g., identification of statistically significant features from a set of available features). As shown, the data preprocessing module 141 may be common to any training module used. The output of the data preprocessing module 141 is input to the machine learning training module 143, which may include any one, any combination, or all of: PES, VVS, MVVS and AI. Other ML-models are contemplated. The output of the machine learning training module 143 is input to testing module 144, which may comprise one or more testing units for each training module and comparison 145. For example, the different price estimation models generated, whether based on PES, VVS, MVVS, or AI may be tested by measuring the performance based on historical data. In effect, the price estimation models use as input the features from the vehicles in the historical data, and determine how well the predicted prices generated by respective price estimation models match to the actual sales prices of the vehicles from the historical data. For example, if the price estimation model is at least 90% or 95% accurate (based on comparison with historical data), the price estimation model is considered sufficiently accurate for use. The output of the testing module 144 may be input to inference module 146, which may generate respective prices (price 1 (147), price 2 (148), price 3 (149)) for the different models.

As one example, the MVVS building and prediction process may comprise the following steps:

1. subdivide the entire training data set based on make, model and trim, and each division will have a corresponding MVVS model;

2. apply outlier detection algorithm on the training data and remove outliers;

3. build a model on a bootstrapped sample, make a prediction on the incoming record;

4. calculate the residuals from the model by subtracting the prediction from the true for each point in the training set;

5. randomly select a residual from step 4 and add onto the prediction from step 3, record this value;

6. repeat steps (e.g., 3-5 k times), and obtain an array of values that can be used to calculate the prediction interval;

7. use a prediction range min and max (e.g., the prediction range min and max are 2.5% and 97.% percentiles) of the array from step 6; and

8. the final prediction is the average of prediction min and max

For both MVVS and VVS: some test data may not have prediction results due to lack of training data: for example, if a particular make/model/trim has no record in the training set, the corresponding MVVS model for the make/model/trim may not be able to be built and therefore no prediction can be made.

In one implementation, the MVVS models may be linear in nature in the sense that the estimated price changes linearly with age and mileage. In this regard, the linear approximation works better on some types of vehicles better than others. Thus, prior to (or after) generating the MVVS model, a measure of linearity may be defined that acts as a criterion to qualify MVVS models: if the training data has too low of a linearity, an MVVS model may not be built; on the other hand, if the linearity is higher than the predefined threshold, an MVVS model may be built. In one implementation, the first step is to remove the outliers in the model with clustering techniques. The basic idea is to filter age-mileage pairs based on the average distance between all pairs. This may eliminate far away points. However, the data may be very noisy. In that regard, 1D convolution may be applied to obtain the “base line”,

The “goodness” or reliability of a model may be defined in several ways. For example, in one way, a “good” model is defined as having more than 80% good predictions for the testing data. Further, a “perfect” model is defined as having 100% good predictions for the testing data.

The MVVS (with trim) and VVS have about the same level of performance on overall # of trades. However, MVVS (with trim) has a much higher ratio for high performance models.

As discussed above, multiple price estimation models may be generated. The price estimation model deemed most accurate (or a plurality (such as 3) price estimation models deemed most accurate) may be used to generate respect GAPs. The risk analysis 151 may include logic to account for the risk associated with the price estimation model(s) used to generate the respective GAPs, and thereafter make a prediction as to the amount of risk (either in terms of a percentage risk or a dollar amount of risk) associated with the prediction of the GAP. FIG. 10 further illustrated vehicle pricing system (VPS) logic 153 configured to generate a vehicle price 154 for use by dealer 155.

FIG. 1D illustrates the second exemplary system 160 (with additional detail) for training and using a vehicle predictive pricing model. As discussed above, VVS or MVVS may be based on a variety of models, such as linear and non-linear models. For example, in one implementation, VVS or MVVS may use both linear and non-linear regression models in the training workflow, including any one, any combination, or all of: XGB Regressor; Random Forest Regression; Decision Tree Regression; Support Vector Regression (SVR); Linear Regression; Extra Trees Regressor; AdaBoost Regression; Partial Least Squares (PLS) Regression; Lasso (least absolute shrinkage and selection operator) Regression; Ridge Regression; Elastic Net Regression; or Kernel Ridge Regression. The listed models are merely for illustration purposes.

Further, the implementation of VVS or MVVS may include multiple stages. For example, FIG. 1D illustrates the architecture with three stages, including the data pre-processing stage 161, the training of the ML models stage 175, and the GAP ML inference stage 191. For example, data from raw database 121 may be input to the data pre-processing stage 161.

In one implementation, the data pre-processing stage 161 comprises one or more functions performed prior to use the data to train the ML models. For example, the data pre-processing stage 161 includes data cleaning 162, feature extraction 163, data filtering 168, feature scaling/feature binarization 171, and bin structure 172 (such as configuring the minimum size of the bins).

Thus, in one example, any one, any combination or all of the following functions may be performed for the data pre-processing stage 161: initial filtering and cleaning data; extracting subvin; calculating age (e.g., in months); extracting trade weekend and quarter; extracting drivetrain; encoding binary labels; binarizing multi labels; detecting univariate outliers; detecting multivariate outliers; feature scaling; assigning bin name and filtering by bin size (e.g., min bin size=100).

After the data pre-processing stage 161, the pre-processed data (stored in the pre-processed database 174) and meta models 173 (such as meta ML models) may be used as input to the training ML models stage 175.

In one implementation, the training ML models stage 175 fits a plurality (such as 12) estimators/regressors on the training dataset, and selects the best model (or the best set of models) with the best score(s) as the best estimator(s) for the subsequent inference stage (e.g., GAP ML inference stage 191).

The training ML models stage 175 may generate multiple models including any one or any combination of: (1) a baseline model (which may be trained using an entire data sample for a respective make/model or a respective make/model/trim (or other feature); or (2) a price bin model (which may be trained using a subset of the data sample for a respective make/model or a respective make/model/trim (or other feature), such as the data only in the data range associated with the price bin or the data in an extended data range around the price bin (such as extending the upper and lower bounds of the data range associated with the price by 25% on either bound so that the range based on the price bin is from a lower range limit to an upper range limit, with the lower range limit being less that the lower price limit by a predetermined percentage (e.g., 25%) of the price bin range, and with the upper range limit being greater that the upper price limit by the predetermined percentage of the price bin range)). As discussed further below with regard to the GAP ML inference stage 191, the baseline model and the price bin model may be used in combination.

As shown in FIG. 1D, the make/model 176 for the respective vehicle subject to analysis may be input to baseline models 179 and clustering algorithm KBinsDiscretizer 177. With regard to baseline models 179, the make/model data may be used to generate a baseline model (which as discussed above may be directed to generating a make/model price estimation model using the entire dataset for the respective make/model or to generating a make/model/trim price estimation model using the entire dataset for the respective make/model/trim).

Clustering algorithm KBinsDiscretizer 177 is configured to generate clusters of data. In this regard, whereas baseline model 179 does not cluster the data (instead using the entire dataset), the price_bin models 192 uses a subset of the dataset. In practice, the output of algorithm KBinsDiscretizer 177 may be used to construct price_bin 178, and then segment/construct the price bins 180. In turn, price_bin models 182 may be created for one, some or all price bins 180. In this regard, the price bins may be determined dynamically based on the cluster analysis of the data (e.g., based on a determination as to the best number of clusters, the best range of clusters, etc.).

In one implementation, clustering may depend on one or both of the density of the data or the distribution of the data. In a specific implementation, the number of clusters may be selected from an upper and lower bound, such as from 2 clusters to 7 clusters. Alternatively, or in addition, the range (such as the price range) of each of the respective clusters may be dynamically selected or may be pre-determined. In particular, the selection of the number of clusters and/or the range of the clusters may depend on dynamic analysis of the data using KBinsDiscretizer.

For example, the Honda Civic has trim levels of EX, EX-L, LX, Sport, and Touring. Certain trim levels, such as the lower end trim levels of EX, EX-L and LX, may have the data more clustered together, resulting in lower number of clusters being generated. Conversely, higher end trim levels, such as the Sport or Touring, may have the data more spread out, potentially resulting in a higher number of clusters being generated. In this way, the later-generated price_bin models may better focus estimating in its respective price bin with less concern about data within the respective price bin being across too great a range. Thus, the price bin strategy may dynamically generate the price bins, with certain price bins have more data (e.g., the data is more clustered together) and other price bins having less data. In turn, the price bin models, generated based on the price bin strategy, may better estimate the prices within the respective price bin. In this regard, segmenting the data via the price bins and thereafter creating the different price bin models may improve the accuracy of the individual bin specific models and/or weakness or unreliability of the data from outside the respective price bin may not undermine the specific price bin model.

The baseline models 179 and the price_bin models 182 may be input to local multivariate outlier detection 181 in order to detect outliers. Thereafter, Subvin label binarizer 183 may be used to assign labels or monikers for different subVINs (e.g., computer may tag different subVINs with different labels.

Thereafter the Training ML models stage 175 may train the models 184. Specifically, train ML models 185 may train baseline model 179 and the price_bin models 182. For example, train ML models 185 may identify the feature(s) that are deemed statistically important. Further, an accuracy assessment 186 is performed (which may receive input from GAP deep learning model 189), in order to determine a level of accuracy for a respective model.

With regard to accuracy assessment, different metrics may be used for accuracy assessment of each of the plurality (e.g., 12) models, with the scores being calculated in order to select the best model (or models). As one example, the model score may be calculated as:

score=((100−accuracy[‘MAPE’])*6+accuracy[‘accuracy_05’]*1+accuracy[‘accuracy_10’]*2+accuracy[‘accuracy_15’]*3)/12

To prevent overfitting issue for low sample bins, the following may be calculated:

diff=abs(rmse_test−rmse_train)*100/rmse_train

score=(test_score*2+(100−diff))/3

The following are the results of the accuracy assessment of the model for different make-model bin structure with and without model parameter tuning:

Top10—All cars—without parameter tuning

{‘MAPE’: 23.57963201164297,

‘MSE’: 5040442.703595344,

‘RMSE’: 2245.0930278265405,

‘accuracy_05’: 25.184062364660026,

‘accuracy_10’: 45.73408401905587,

‘accuracy_15’: 61.065396275443916,

‘buffer_negative’: {‘0.10-0.15’: 357, ‘0.05-0.10’: 495, ‘0-0.05’: 615},

‘buffer_positive’: {‘0.10-0.15’: 351, ‘0.05-0.10’: 454, ‘0-0.05’: 548},

‘score’: 57.217329944806494}

Last10—All cars—without parameter tuning:

{‘MAPE’: 25.277485377439994,

‘MSE’: 3961759.320472634,

‘RMSE’: 1990.4168710279346,

‘accuracy_05’: 28.125,

‘accuracy_10’: 41.875,

‘accuracy_15’: 50.0,

‘buffer_negative’: {‘0.10-0.15’: 8, ‘0.05-0.10’: 9, ‘0-0.05’: 16},

‘buffer_positive’: {‘0.10-0.15’: 5, ‘0.05-0.10’: 13, ‘0-0.05’: 29},

‘score’: 55.538340644613335}

Last10—All cars—with parameter tuning (due to the large computer processing requirement for parameter tuning, the XGBoost regressor model was not used in the experiment below; however, the accuracy results improved by 5%):

{‘MAPE’: 27.42223538266672,

‘MSE’: 5853241.674643868,

‘RMSE’: 2419.3473654363625,

‘accuracy_05’: 29.129129129129126,

‘accuracy_10’: 43.84384384384384,

‘accuracy_15’: 53.153153153153156,

‘buffer_negative’: {‘0.10-0.15’: 14, ‘0.05-0.10’: 24, ‘0-0.05’: 48},

‘buffer_positive’: {‘0.10-0.15’: 17, ‘0.05-0.10’: 25, ‘0-0.05’: 49},

‘score’: 55.30790132768567}

Last10—Normal cars—Without parameter tuning

{‘MAPE’: 15.426382642014467,

‘MSE’: 4454382.613765536,

‘RMSE’: 2110.540834422669,

‘accuracy_05’: 26.70807453416149,

‘accuracy_10’: 58.38509316770186,

‘accuracy_15’: 72.04968944099379,

‘buffer_negative’: {‘0.10-0.15’: 13, ‘0.05-0.10’: 23, ‘0-0.05’: 17},

‘buffer_positive’: {‘0.10-0.15’: 9, ‘0.05-0.10’: 28, ‘0-0.05’: 26},

‘score’: 72.25575277837164}

Top10—Normal cars—without parameter tuning

{‘MAPE’: 15.176564035988067,

‘MSE’: 6761085.406426597,

‘RMSE’: 2600.208723627124,

‘accuracy_05’: 29.737283398546676,

‘accuracy_10’: 53.74510899944103,

‘accuracy_15’: 70.57015092230297,

‘buffer_negative’: {‘0.10-0.15’: 304, ‘0.05-0.10’: 430, ‘0-0.05’: 537},

‘buffer_positive’: {‘0.10-0.15’: 298, ‘0.05-0.10’: 429, ‘0-0.05’: 527},

‘score’: 71.4898808290341}

Definition of normal car: mileage_in_km<=250 k & age<=120 month

The top models are then saved (e.g., save best 3 models 187), and risk analysis 188 is performed (such as risk model on offsets)). Risk analysis 188 may be directed to determining a risk associated with a certain GAP. As discussed above, if the GAP is too high (e.g., the predicted price is higher than the true price and/or is higher than the expected maximum bid), there is a risk of loss. Risk analysis 188 comprises a mechanism to assess the risk. For example, after creating the model(s), the system may add one or more offsets (such as arbitrary offsets). For example, the offset may be in a range from 0 to 50% on the testing dataset. Thereafter, the system may predict the price. The system may then evaluate the offset, apply the offset to the predicted price, and compare the predicted price and offset to the actual price (from the testing dataset). Thereafter, the system may calculate the loss (e.g., the difference between the predicted price and actual price) and the associated risk. For example, if the predicted price is greater than the actual price, the system may create two different models, an offset risk model and an offset loss model for each make/model/price bin. Various acceptance criterion or criteria, such as a percentage of acceptance or dollar amount of loss per trade, may be used. The acceptance criteria of loss and the risk (e.g., 5% and $100/trade loss comprise the acceptance criteria) may be input to the offset risk/loss models, with the outputs comprising the calculated offset risk percentage. In this regard, the offset may be indicative of how much to reduce the predicted price in order to achieve an acceptable risk level.

The generated ML models, meta models, accuracy results, risk models, and loss models 190 may be input to GAP ML inference stage 191. A vehicle condition report (CR) 192 may be input to block 193, which may determine whether the vehicle in considered a global outlier. If so, no GAP is generated 194. Further, the make/model is extracted at 195, and a local outlier determination 196 is performed. If it is determined to be a local outlier, no GAP is generated 194.

At 197, the baseline model is run in order to determine the best model 198. From the best model, at 199, the estimated price is calculated. For example, the baseline model may be used as an initial price estimate, which may then be used to find the respective price bin (see find price_bin 199-1) in order to run the price_bin model (199-2). For example, if the initial value from the baseline model is determined to be $10,000, the price_bin with that value (such as price_bin 3, discussed above), may be selected in order to generate the price_bin model for the respective price_bin selected. At 199-3, the most accurate model(s), such as the 3 most accurate models, are identified. Further, at 199-4, the predicted prices are calculated using the 3 most accurate models. At 199-7, the GAP_price may be calculated based on any one, any combination, or all of the predicted prices (e.g., the minimum of the predicted prices calculated using the 3 most accurate models). Further, at 199-5, the risk associated with the price_bin may be calculated (e.g., based on the price_bin model associated with the specific price_bin). The GAP_price and the price_bin risk may be input to 199-6 for the risk and loss thresholds (e.g., 5% risk and $100 loss). At 199-8, the offset for the make/model/price_bin may be calculated, which in turn may be used at 199-9 to generate the final GAP price.

FIG. 2 illustrates exemplary computer architecture for computer system 200. Computer system 200 includes a network interface 220 that allows communication with other computers via a network 226, where network 226 may be represented by network 108 in FIGS. 1A-D. Network 226 may be any suitable network and may support any appropriate protocol suitable for communication to computer system 200. In an implementation, network 226 may support wireless communications. In another implementation, network 226 may support hard-wired communications, such as a telephone line or cable. In another implementation, network 226 may support the Ethernet IEEE (Institute of Electrical and Electronics Engineers) 802.3x specification. In another implementation, network 226 may be the Internet and may support IP (Internet Protocol). In another implementation, network 226 may be a LAN or a WAN. In another implementation, network 226 may be a hotspot service provider network. In another implementation, network 226 may be an intranet. In another implementation, network 226 may be a GPRS (General Packet Radio Service) network. In another implementation, network 226 may be any appropriate cellular data network or cell-based radio network technology. In another implementation, network 226 may be an IEEE 802.11 wireless network. In still another implementation, network 226 may be any suitable network or combination of networks. Although one network 226 is shown in FIG. 2, network 226 may be representative of any number of networks (of the same or different types) that may be utilized.

The computer system 200 may also include a processor 202, a main memory 204, a static memory 206, an output device 210 (e.g., a display or speaker), an input device 212, and a storage device 216, communicating via a bus 208.

Processor 202 represents a central processing unit of any type of architecture, such as a CISC (Complex Instruction Set Computing), RISC (Reduced Instruction Set Computing), VLIW (Very Long Instruction Word), or a hybrid architecture, although any appropriate processor may be used. Processor 202 executes instructions 224 stored on one or more of the main memory 204, static memory 206, or storage device 215. Processor 202 may also include portions of the computer system 200 that control the operation of the entire computer system 200. Processor 202 may also represent a controller that organizes data and program storage in memory and transfers data and other information between the various parts of the computer system 200.

Processor 202 is configured to receive input data and/or user commands through input device 212. Input device 212 may be a keyboard, mouse or other pointing device, trackball, scroll, button, touchpad, touch screen, keypad, microphone, speech recognition device, video recognition device, accelerometer, gyroscope, global positioning system (GPS) transceiver, or any other appropriate mechanism for the user to input data to computer system 200 and control operation of computer system 200 and/or operation of the predictive pricing application 115. Input device 212 as illustrated in FIG. 2 may be representative of any number and type of input devices.

Processor 202 may also communicate with other computer systems via network 226 to receive instructions 224, where processor 202 may control the storage of such instructions 224 into any one or more of the main memory 204 (e.g., random access memory (RAM)), static memory 206 (e.g., read only memory (ROM)), or the storage device 216. Processor 202 may then read and execute instructions 224 from any one or more of the main memory 204, static memory 206, or storage device 216. The instructions 224 may also be stored onto any one or more of the main memory 204, static memory 206, or storage device 216 through other sources. The instructions 224 may correspond to, for example, instructions that Price Model management application 106 or predictive pricing application 115 illustrated in FIG. 1A.

Although computer system 200 is represented in FIG. 2 as a single processor 202 and a single bus 208, the disclosed implementations applies equally to computer systems that may have multiple processors and to computer systems that may have multiple busses with some or all performing different functions in different ways.

Storage device 216 represents one or more mechanisms for storing data. For example, storage device 216 may include a computer readable medium 222 such as read-only memory (ROM), RAM, non-volatile storage media, optical storage media, flash memory devices, and/or other machine-readable media. In other implementations, any appropriate type of storage device may be used. Although only one storage device 216 is shown, multiple storage devices and multiple types of storage devices may be present. Further, although computer system 200 is drawn to contain the storage device 216, it may be distributed across other computer systems that are in communication with computer system 200, such as a server in communication with computer system 200. For example, when computer system 200 is representative of communication device 110, storage device 216 may be distributed across to application server 102 when communication device 110 is in communication with application server 102 during operation of the Price Model management application 106 and/or predictive pricing application 115.

Storage device 216 may include a controller (not shown) and a computer readable medium 222 having instructions 224 capable of being executed by processor 202 to carry out functions of the Price Model management application 106 and/or predictive pricing application 115. In another implementation, some or all of the functions are carried out via hardware in lieu of a processor-based system. In one implementation, the controller included in storage device 216 is a web application browser, but in other implementations the controller may be a database system, a file system, an electronic mail system, a media manager, an image manager, or may include any other functions capable of accessing data items. Storage device 216 may also contain additional software and data (not shown), for implementing described features.

Output device 210 is configured to present information to the user. For example, output device 210 may be a display such as a liquid crystal display (LCD), a gas or plasma-based flat-panel display, or a traditional cathode-ray tube (CRT) display or other well-known type of display in the art of computer hardware. Accordingly, in some implementations output device 210 displays a user interface. In other implementations, output device 210 may be a speaker configured to output audible information to the user. In still other implementations, any combination of output devices may be represented by the output device 210.

Network interface 220 provides the computer system 200 with connectivity to the network 226 through any compatible communications protocol. Network interface 220 sends and/or receives data from the network 226 via a wireless or wired transceiver 214. Transceiver 214 may be a cellular frequency, radio frequency (RF), infrared (IR) or any of a number of known wireless or wired transmission systems capable of communicating with network 226 or other computer device having some or all of the features of computer system 200. Bus 208 may represent one or more busses, e.g., USB, PCI, ISA (Industry Standard Architecture), X-Bus, EISA (Extended Industry Standard Architecture), or any other appropriate bus and/or bridge (also called a bus controller). Network interface 220 as illustrated in FIG. 2 may be representative of a single network interface card configured to communicate with one or more different data sources.

Computer system 200 may be implemented using any suitable hardware and/or software, such as a personal computer or other electronic computing device. In addition, computer system 200 may also be a portable computer, laptop, tablet or notebook computer, PDA, pocket computer, appliance, telephone, server computer device, or mainframe computer.

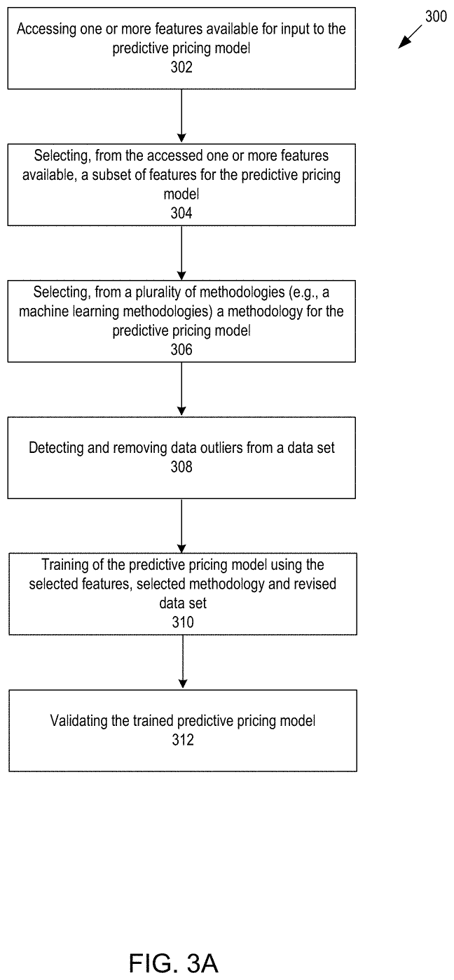

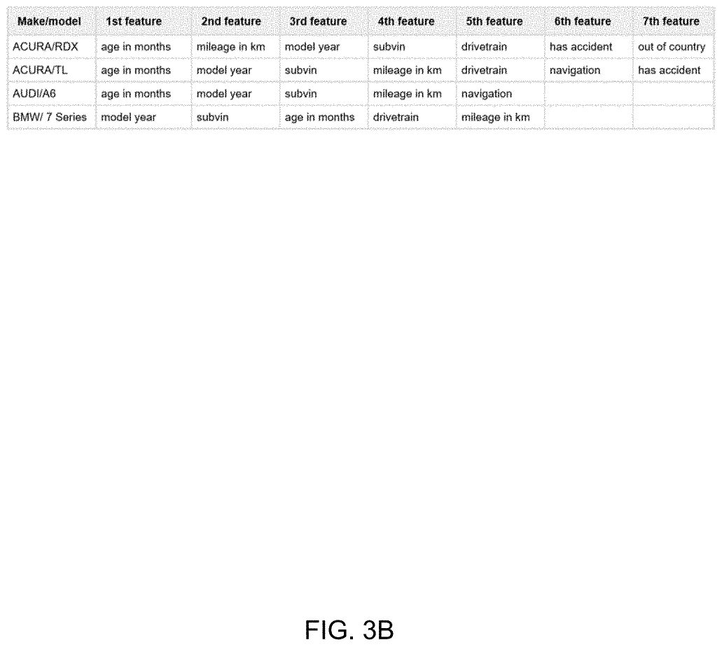

FIG. 3A illustrates an exemplary flow diagram 300 of logic to generate a predictive pricing model. At 302, one or more features available for input to the predictive pricing model are accessed. At 304, a subset of features is selected, from the accessed one or more features, for the predictive pricing model.

Different types of features may be accessed including categorical features and continuous features. Examples of categorical features may include, without limitation, any one, any combination, or all of: seller's province mileage; digits 4 to 8 of the VIN (encoding body style and engine type); history of accidents (e.g., yes/no); damages over $3,000.00 (e.g., yes/no); normalized color (e.g., Norm=Black/White/Silver/Grey; otherwise non-normalized); drivetrain type (e.g., FWD, 4WD, AWD); transmission type (e.g., automatic or manual); options: navigation (yes/no), sunroof (yes/no), air conditioning (yes/no); most important disclosures: windshield condition (chipped (driver side), chipped (passenger side), cracked), tire condition (e.g., needs 1 tire, 2 tires, etc.); model year; and season. Examples of continuous features include, without limitation, any one, any combination, or all of: mileage (e.g., in kilometers); and age of date trade was created (e.g., age in months). The above-mentioned features may comprise a set of price influencers via feature importance calculations. Other possible price correlates may be considered, such as the summary of damages (e.g., in the form of the total number of damage images). However, there may be no correlation between damages and prices, and there may be an adverse effect of damage feature presence.

Through incorporating feature selection (based on importance values of each feature) into the data processing pipeline (e.g., preceding the training step), one may discover a subset of important features specific to each car brand sold, such as shown in FIG. 3B. Specifically, the examples in FIG. 3B illustrate different feature subsets listed in a descending order of their importance for different brands. Make/model-specific feature learning may thus identify strong price predictors in the feature “superset” and may form the best feature representation of the car brand for predictive price modelling.

At 306, a methodology is selected, from the plurality of methodologies, for the predictive pricing model. For example, a multi-algorithmic approach may be used where for each of the plurality of predictive models for a specific make/model, the best performing machine learning algorithm is selected. Example algorithms include, but are not limited to: Linear Regression; Decision Tree Regression; Bagging Regression; Random Forest Regression; Support Vector Regression; Extra Trees Regression; Ada Boost Regression; Partial Least Squares Regression; and Gradient Boosting Regression.

Therefore, there may be no assumption on linear or non-linear relationship between the price and its covariates (e.g., selected features), and the choice of a learning algorithm may be make/model data-driven. The algorithm performance metric used may be a cross-validation score, such as the coefficient of determination.

At 308, data outliers from the data set may be detected and removed. For example, during repeated training of the best performing algorithm on the observations of selected features using 10-fold cross-validation, price prediction errors may be recorded for each testing vehicle example. From the distribution of errors, one may deduce outliers. One may define them as those vehicles whose prediction error is greater than two standard deviations away from the mean error. The influence of outliers on the performance of the chosen algorithm may be automatically detected by means of training on the dataset without outliers and computing the cross-validation score. Evaluation of the outlier influence performed for all make/models shows that outliers have a potential to significantly undermine the predictive accuracy. As such, outlier removal is routinely used in order to prepare data for the final training.

At 310, the training of the predictive pricing model is performed using the selected features, selected methodology and the revised data set. At 312, the trained predictive pricing model is validated.

Through experimentation, one may determine that it is better to segment low-end vehicles from the make/model sample and to build a separate regression model for low-end vehicle value. Most car brands do not have enough records for low-end vehicles (e.g., defined as those with a mileage greater than 200,000 km and age greater than 10 years). If not segmented, the values of these vehicles, in particular if they fall under $1,000.00 in value, may be significantly overestimated by a regressor trained on the entire brand sample. This definition allows to identify low-end type from an incoming vehicle price request. In this case, the algorithm returns either (a) the price range for the requested province and model year (based on the past 6 months of sales) and the median of the subsample found in this price range or (b) the vehicle value and the predicted price interval forecasted by a low-end regression model (if the segmented data has a sufficient number of records to build a reliable model). Low-end prices in the training dataset may be logarithmically transformed in order to reduce price variation with respect to slowly changing major price covariates (e.g., age and mileage) and thus to increase their correlation.

Further, if the vehicle price is best modelled by a linear regression, then prediction intervals may be computed using a statistical formula for a standard error. Otherwise, for ensemble methods such as random forests, the lower and upper bounds of the price interval are forecasted using two-dimensional interpolating surfaces that represent the mean price and the mean residual (e.g., the difference between true and mean prices computed for each vehicle in the sample) as functions of vehicle age and mileage. Specifically, first, one may predict if the forecast is an overestimate or underestimate (such as by comparing the forecast to the forecasted mean price). Then, if the forecast is determined to be an overestimate, the returned interval is (a) [mean price−mean residual, forecast] if the forecast is greater than the mean price or (b) [forecast-mean residual, forecast] if the forecast is less than the mean price. Otherwise, the interval is (a) [forecast, mean price+mean residual] if forecast is less than the mean price or (b) [forecast, forecast+mean residual] if the forecast is greater than the mean price. The width of such an interval varies from one requested vehicle to another. The wider the interval is, the more uncertain the predicted price may be.

FIG. 4 illustrates a block diagram 400 for a methodology to build accurate predictive pricing models. As illustrated, depending on the dataset, certain relevant features 402 are used. For example, when using the first dataset (such as normal conditions 404), features 1-11 may be used. Conversely, when using the second dataset (such as segmentation of low end vehicle sold 406), certain features may be removed. Further, in one implementation, the second dataset may include the first dataset. Alternatively, the second dataset may be entirely different from the first dataset. Further, as shown, the type of sale (e.g., “as_is”) may determine the features used. At 408, a multi-algorithmic approach may be used.

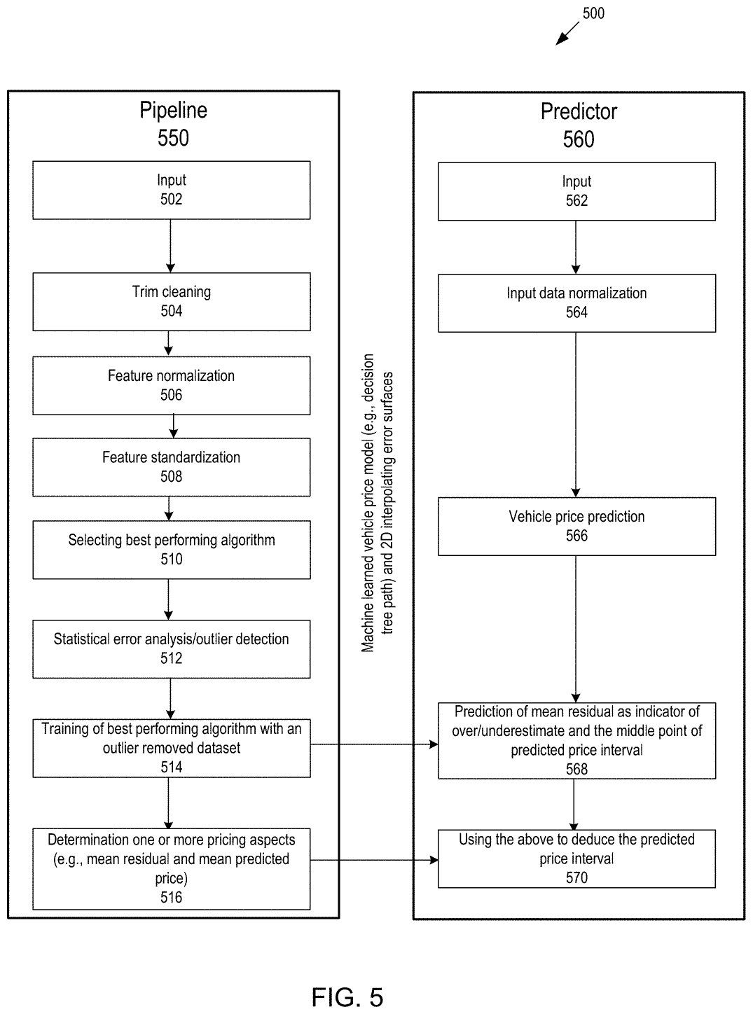

FIG. 5 illustrates a block diagram 500 for an algorithm structure to generate and use a predictive pricing model. Specifically, pipeline 550 includes at 502, input, such as feature observations (e.g., MySQL table rows) totaling at least a predetermined number (e.g., 50). At 504, trim cleaning is performed, which may comprise fixing obvious errors, such as varying spacing between words and identification of similar trim names where similarity measure for trims is defined differently for different companies. At 506, feature normalization is performed, which may comprise mapping of features of string type such as province or trim to integers, mapping of sale dates to seasons, computing vehicle age, and/or removal of binary features with the same value. At 508, feature standardization is performed, which may be for linear, partial least squares and support vector regressors only. At 510, the best performing algorithm, such as by using a multi-algorithmic approach, is selected. At 512, statistical error analysis/outlier detection is performed, which may be performed via 10-fold-cross-validation of the best performing algorithm). Outliers may comprise vehicle records in the testing dataset whose corresponding errors are greater than 3 standard deviations away from the error mean. At 514, training of the best performing algorithm with an outlier removed dataset is performed. At 516, the determination of one or more pricing aspects is performed. Specifically, calculation of the mean residual (e.g., the difference between the mean predicted price and its true value) and the mean predicted price may be performed for each training example and surface fitting of both quantities viewed as functions of age and mileage.

With regard to the predictor 560, at 562, data is input, such as vehicle features (e.g., as given in MySQL database of sold vehicles). At 564, input data is normalized. At 566, vehicle price is predicted. At 568, prediction of mean residual as indicator of over/underestimate and the middle point of predicted price interval is performed. At 570, the above calculations are used to decide the predicted price interval.

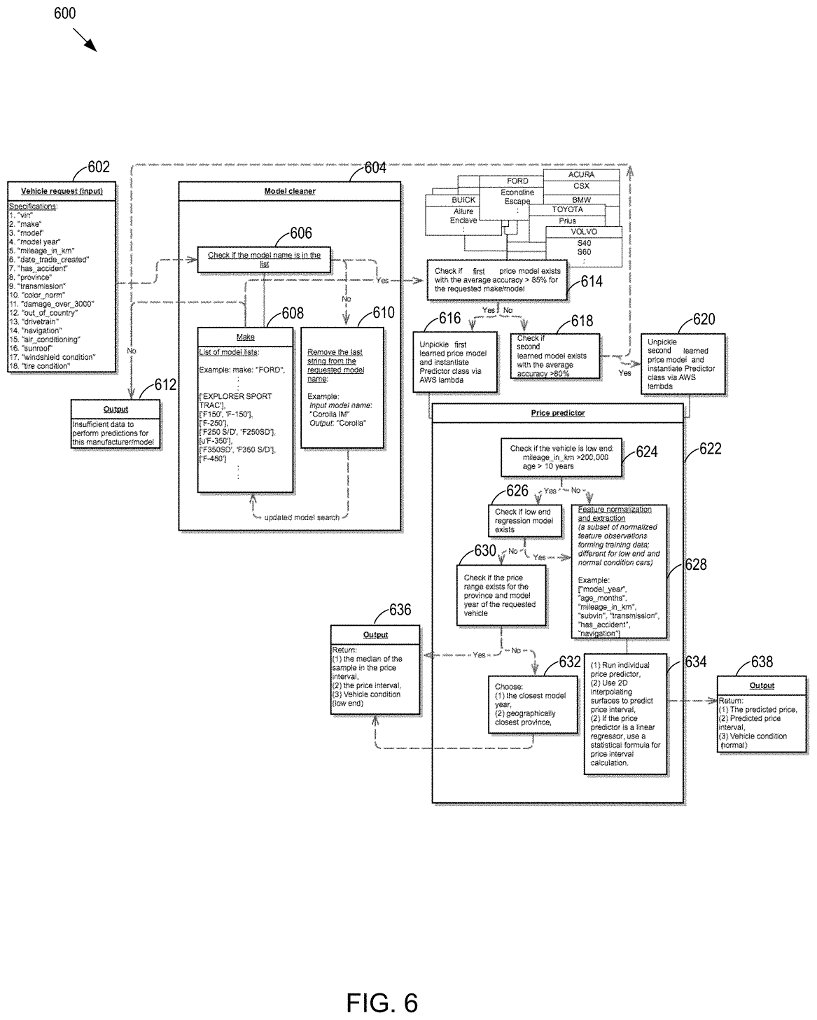

FIG. 6 illustrates an exemplary flow diagram 600 for vehicle valuation using one or more predictive pricing models. At 602, the vehicle request includes one or more inputs, such as listed in FIG. 6. The inputs may be input to model cleaner 604, which may include at 606 checking if the model name is in the list. If not, at 610, the last string from the requested model name may be removed, and an updated model search may be performed at 608. If the model name is still not found, at 612, an output may be generated, with the output indicative that insufficient data is available to perform the prediction.

At 614, it is checked whether a first price model exists with an accuracy above a predetermined amount (e.g., 85%) for the requested make/model. If so, at 616, the first learned price model is unpickled and a predictor class is instantiated. If not, at 618, it is checked whether a second price model exists with an accuracy above a another predetermined amount (e.g., 80%) for the requested make/model. If so, at 620, the second learned price model is unpickled and a predictor class is instantiated. If not, flow diagram 600 moves to 612.

With the price predictor 622, at 624, the vehicle is checked if it is low end (e.g., mileage>200,000 and/or age>10 years). If so, at 626, it is determined whether the low end regression model exists. If so, flow diagram moves to 628. If not, at 630, the system checks if the price range exists for the province (e.g., geographical location) and model year of the requested vehicle. If so, at 636, the output is returned as the median of the sample in the price interval; the price interval; and the vehicle condition. If not, at 632, the closest model year and the geographically closest province is selected.

At 628, feature normalization and extraction is performed whereby a subset of normalized feature observations may be identified, which may be different for low-end and normal condition vehicles. At 634, the system runs individual price predictors; uses 2D interpolating surfaces to predict price interval; and if the price predictor is a linear regressor, uses a statistical formula for the price interval calculation. At 638, the output is returned, which may include any one, any combination or all of: the predicted price; the predicted price interval; or the vehicle condition.

As discussed above, Guaranteed Auction Price (GAP) comprises a guaranteed price (e.g., set_price) for the consumer at which the vehicle is sold at auction. In practice, if the price is attractive enough, the consumer will undergo the sale process (whether at a dealership or elsewhere) to begin a bidding process that returns a final sell price (true_price). The risk of GAP is: if true_price<set_price, the guarantor must pay the difference (set_price−true_price) and incur a loss. The guarantor may charge a fee on each trade; therefore, the net profit may comprise: (Fee−max(0, set_price−true_price)).

Separate from affecting the profit, the set_price may affect the probability of the trade actually occurring. Specifically, the buyer may be more willing to execute the trade at a lower set_price, and the seller may be more willing to execute the trade at a higher set_price. In other words, the price may either be too low or too high to make the trade happen. This probability may be manifested as Prob(set_price), which may be a function of set_price. Thus, modifying the equation above, the expected profit (EP) comprises Prob(set_price)×(Fee−max(0, set_price−true_price)). In one implementation, this value may be maximized by setting the correct set_price. In order to calculate Prob(set_price), one or more assumptions may be made including: the probability of a trade happening is proportional to the number of trades sold at a particular price.

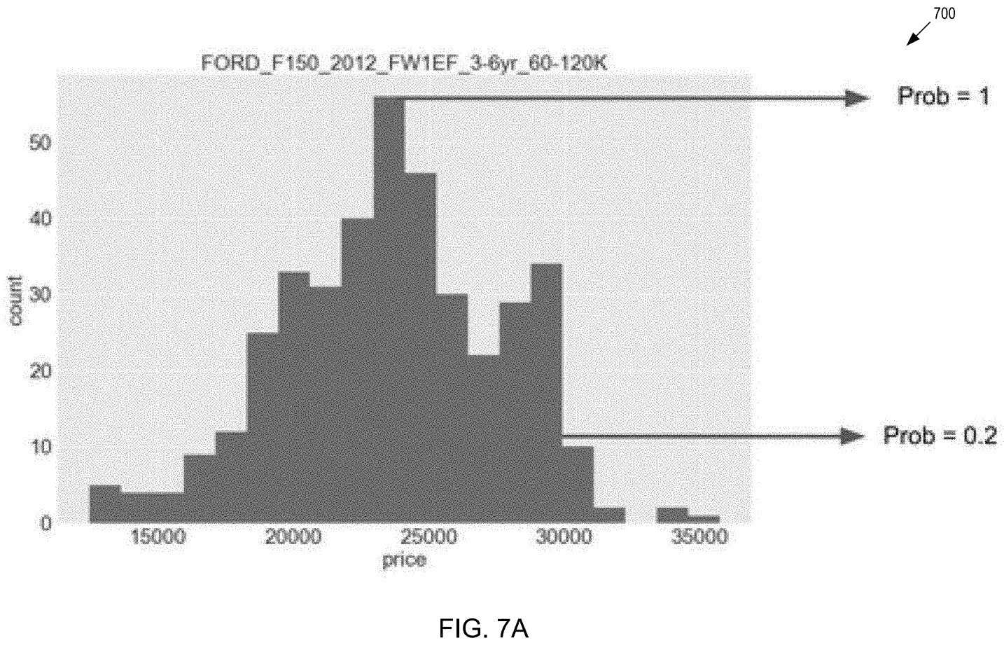

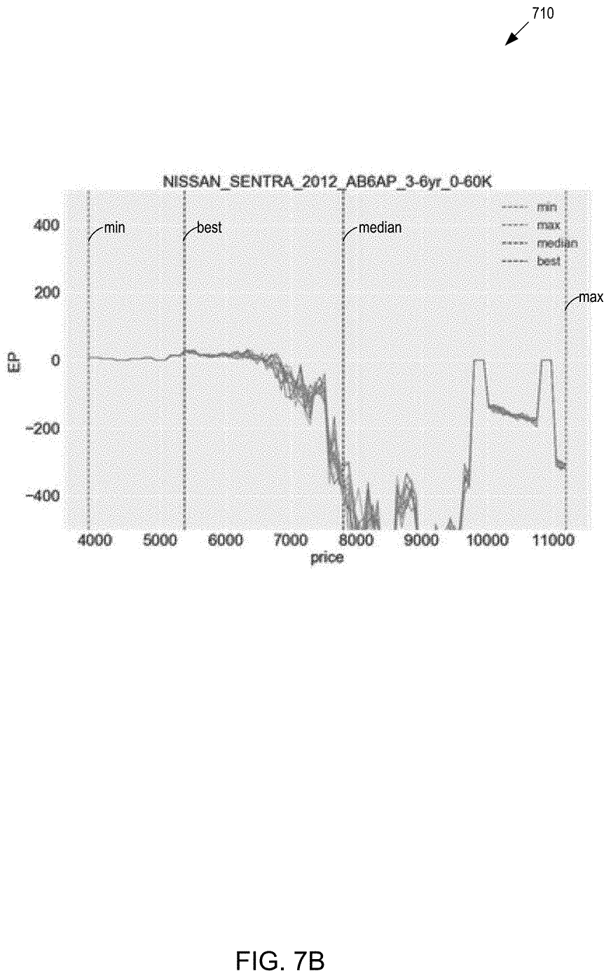

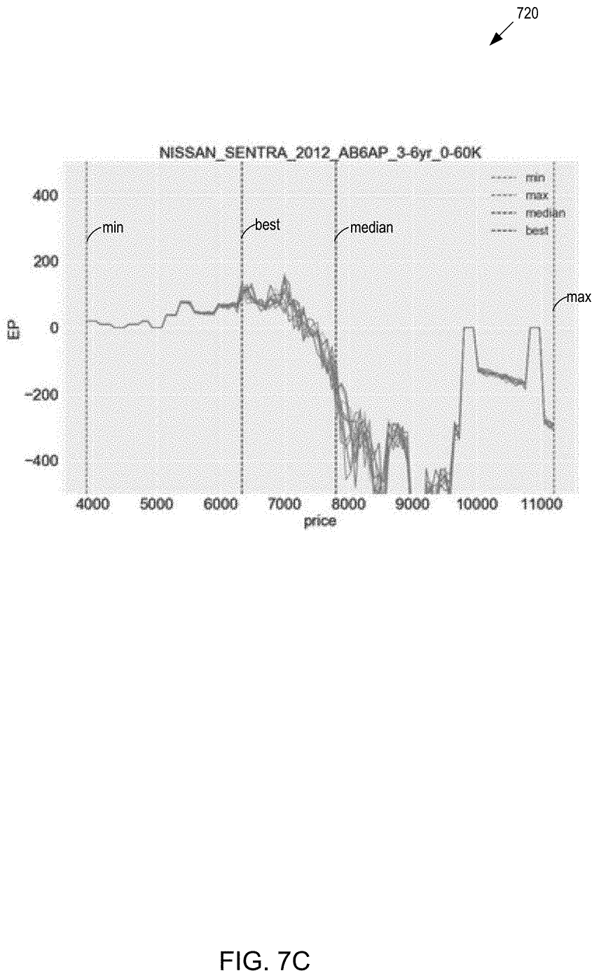

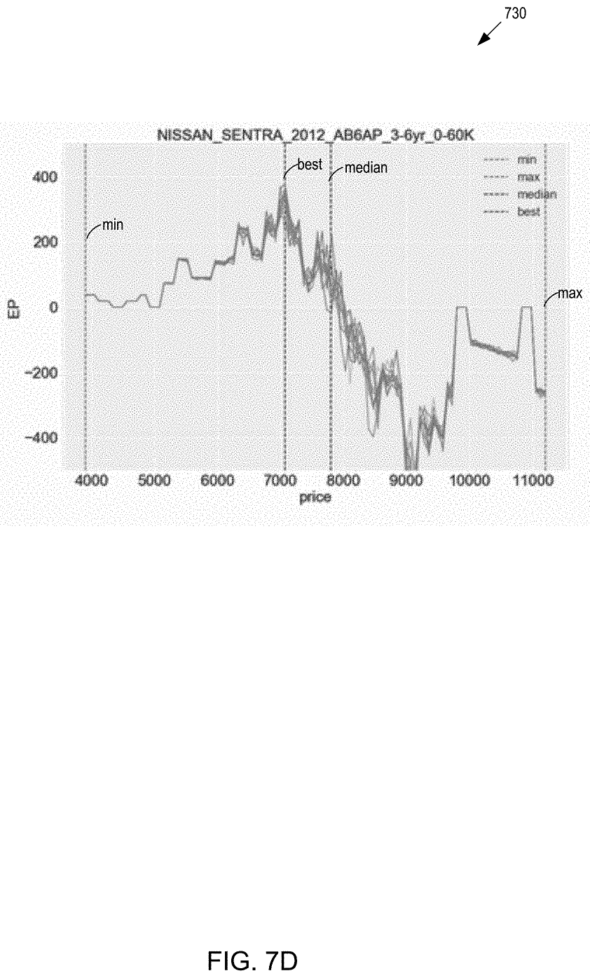

FIG. 7A illustrates a histogram 700 in which the probability is benchmarked to 1 for the most popular price (24000), and assume that a future trade set at 24000 will be sold at one (1) standard probability. In one implementation, one standard probability does not necessarily have to be 100% since it simply may be compared to probabilities for other prices. In comparison, the probability is approximately 0.2 standard probability at set_price=30000 (as shown in FIG. 7A) because the number of historic trades sold at this price is 20% of the top count which occurred at 24000. In practice, the probability of a trade sold to its set_price may be linked.

With the above framework, a simulation may be performed. One goal of the simulation is to determine the expected profit for a particular grid (price estimate service combination) for a period of time in the future. The methodology may start with a fixed value of set_price. The number of samples for the simulation, K, may be selected as projected sales volume for next year. This selection may be used to ensure the simulation reflects the real world. The mean value EP_mean may be obtained of all simulations out of K values. In practice, the simulation may be executed N times, thereby resulting in N values of EP_mean for a set_price. EP_mean(s) for the N iterations may have a range. In one implementation, the range of EP_mean(s) for the N iterations is not overly wide and an indicates a trend (which may be gleaned through analysis). As a final step, set_price may be varied to obtain different ranges for EP_mean. Thereafter, the different ranges for EP_mean for the different set_price selections may be analyzed to determine a best value for set_price. From a practical standpoint: N=10 may be sufficient to identify the trend.

FIGS. 7B-D illustrate different graphs where K=151, N=10, and with different values of set_price including $120 (graph 710 in FIG. 7B), $320 (graph 720 in FIG. 7C) and $600 (graph 730 in FIG. 7D). Further, the optimal set_price is less than the median. Specifically, if set_price is median, it may incur a heavy loss over time. In addition, as the fee increases, the best set_price may move towards median but remain lower than median.

The methods, devices, processing, circuitry, and logic described above may be implemented in many different ways and in many different combinations of hardware and software. For example, all or parts of the implementations may be circuitry that includes an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry may store or access instructions for execution, or may implement its functionality in hardware alone. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed. For instance, the circuitry may include multiple distinct system components, such as multiple processors and memories, and may span multiple distributed processing systems. Parameters, databases, and other data structures may be separately stored and managed, may be incorporated into a single memory or database, may be logically and physically organized in many different ways, and may be implemented in many different ways. Example implementations include linked lists, program variables, hash tables, arrays, records (e.g., database records), objects, and implicit storage mechanisms. Instructions may form parts (e.g., subroutines or other code sections) of a single program, may form multiple separate programs, may be distributed across multiple memories and processors, and may be implemented in many different ways. Example implementations include stand-alone programs, and as part of a library, such as a shared library like a Dynamic Link Library (DLL). The library, for example, may contain shared data and one or more shared programs that include instructions that perform any of the processing described above or illustrated in the drawings, when executed by the circuitry.

The following example embodiments of the invention are also disclosed:

### Embodiment 1

A system comprising:

a communication interface configured to communicate with a database, the database storing sales for a specific make/model of a vehicle; and

a controller in communication with the communication interface, the controller configured to generate a plurality of predictive pricing models for the specific make/model of the vehicle, the plurality of predictive pricing models for the specific make/model of the vehicle being configured to generate a predicted price, using at least one of the plurality of predictive pricing models, for a vehicle subject to sale based on at least one of the following: disclosures particular to the vehicle subject to sale; options of the vehicle subject to sale; and history of accidents for the vehicle subject to sale.

### Embodiment 2

The system of embodiment 1, wherein the plurality of predictive pricing models is configured to generate the predicted price based on the disclosures particular to the vehicle subject to sale; the options of the vehicle subject to sale; and the history of accidents for the vehicle subject to sale.

### Embodiment 3

The system of any of embodiments 1 or 2, wherein the disclosures particular to the vehicle subject to sale comprises necessary repairs to the vehicle subject to sale.

### Embodiment 4

A system comprising:

a communication interface configured to communicate with a database, the database storing sales for a specific make/model of a vehicle; and

a controller in communication with the communication interface, the controller configured to generate a plurality of predictive pricing models for the specific make/model of the vehicle by using a stochastic methodology and by using at least two features of the specific make/model of the vehicle in order to determine at least one pricing aspect of a vehicle by interpolating 2D surfaces in a neighborhood of the at least two features of the vehicle.

### Embodiment 5

The system of embodiment 4, wherein the stochastic methodology comprises random forests regressor.

### Embodiment 6

The system of any of embodiments 4 or 5, wherein the at least two features of the vehicle comprise mileage and age.

### Embodiment 7

A system comprising:

a communication interface configured to communicate with a database, the database storing sales for a specific make/model of a vehicle; and

a controller in communication with the communication interface, the controller configured to:
access one or more of a plurality of predictive pricing models for the specific make/model of the vehicle and for a discrete number of trim levels;
use the one or more of the plurality of predictive pricing models for the specific make/model of the vehicle in order to perform a trim level similarity operation in order to determine a trim level nearest to a trim level of vehicle subject to sale; and
use the performed trim level similarity operation to determine a price range of the vehicle subject to sale.

What is claimed is:

1. A system comprising:
a communication interface configured to communicate with a database, the database storing sales for a specific make/model of a vehicle; and
a controller in communication with the communication interface, the controller configured to generate a plurality of predictive pricing models for the specific make/model of the vehicle, for each of the plurality of predictive pricing models, by:
performing feature determination to determine a respective set of features, selected from an available set of features, for the respective predictive pricing model;
selecting a learning methodology, from a plurality of potential learning methodologies; and
training the respective predictive pricing model using the determined respective set of features and the selected learning methodology.

2. The system of claim 1, wherein a first predictive pricing model for the specific make/model of the vehicle has a first subset of features and a second predictive pricing model for the specific make/model of the vehicle has a second subset of features; and
wherein the first subset of features is at least partly different than the second subset of features.

3. The system of claim 2, wherein one of the features in the available set of features comprises manufacturer's suggested retail price.

4. The system of claim 3, wherein plurality of predictive pricing models are configured, using an MSRP, to generate current price information for a vehicle subject to sale or to generate future price information for the vehicle subject to sale.

5. The system of claim 2, wherein a first machine learning methodology is used to generate the first predictive pricing model for the specific make/model of the vehicle;
wherein a second machine learning methodology is used to generate the second predictive pricing model for the specific make/model of the vehicle; and
wherein the first machine learning methodology is different from the second machine learning methodology.

6. The system of claim 5, wherein the controller is further configured to:
perform, for the first predictive pricing model, outlier detection to remove a first subset of data from the sales in the database in order to generate first set of sales data for training the first predictive pricing model; and
perform, for the second predictive pricing model, the outlier detection to remove a second subset of data from the sales in the database in order to generate second set of sales data for training the second predictive pricing model,
wherein the first set of sales data is different from the second set of sales data.

7. The system of claim 1, wherein the specific make/model includes a specific make/model/first trim and a specific make/model/second trim;
wherein the controller is configured to generate the predictive pricing models for the specific make/model/first trim and the specific make/model/second trim of the vehicle by;
performing the feature determination to determine a respective set of features, selected from the available set of features, for the specific make/model/first trim predictive pricing model and the specific make/model/second trim predictive pricing model;
selecting a learning methodology, from a plurality of potential learning methodologies; and
training the specific make/model/first trim predictive pricing model and the specific make/model/second trim predictive pricing model using the determined respective set of features and the selected learning methodology.

8. The system of claim 7, wherein the specific make/model/first trim predictive pricing model comprises a baseline specific make/model/first trim predictive pricing model trained using historical pricing data for vehicles with the specific make/model/first trim and configured to generate an initial price estimate for the vehicle;
wherein the controller is further configured to:
cluster the historical pricing data for vehicles with the make/model/first trim sold in the price range into at least a first cluster and a second cluster, the first cluster associated with a first price bin, the second cluster associated with a second price bin;
generate at least one of a first price bin estimation model or a second first price bin estimation model, the first price bin estimation model trained based on the historical pricing data for the vehicles with the make/model/first trim sold in a first range based on the first price bin, the second range based on the price bin being narrower than the price range, the second price bin estimation model trained based on the historical pricing data for the vehicles with the make/model/first trim sold in a second range based on the second price bin, the second range based on the price bin being narrower than the price range;
responsive to determining that the initial price estimate is within the first price bin, use the first price bin estimation model to generate a first price bin estimate; and
responsive to determining that the initial price estimate is within the second price bin, use the second price bin estimation model to generate a first price bin estimate.

9. A system comprising:
a communication interface configured to communicate with a database, the database storing sales for a specific make/model of a vehicle; and
a controller in communication with the communication interface, the controller configured to generate a plurality of predictive pricing models for the specific make/model of the vehicle, the plurality of predictive pricing models for the specific make/model of the vehicle being differentiated based on at least one of the following: type of sale; data used; or age or mileage of vehicle.

10. The system of claim 9, wherein the type of sale comprises an “As-is” or a warranty-associated auction.

11. The system of claim 9, wherein the data used comprises whether the data is sourced from a first company or from a second company.

12. A method for using multiple price estimation models in order to generate an estimated price for a vehicle, wherein the vehicle includes features comprising make, model, and at least one vehicle feature, the method comprising:
accessing a baseline price estimation model for the make and model of the vehicle, the baseline price estimation model trained based on historical pricing data for vehicles with the make and model sold in a price range;
generating, using the baseline price estimation model and the at least one vehicle feature, an initial price estimate;
responsive to determining that the initial price estimate is within a price bin, accessing a price bin estimation model, the price bin estimation model trained based on the historical pricing data for the vehicles with the make and model sold in a range based on the price bin, the range based on the price bin being narrower than the price range;
generating, using the price bin estimation model and the at least one vehicle feature, a price bin estimate; and
use one or both of the initial price estimate or the price bin estimate with regard to a sale of the vehicle.

13. The method of claim 12, wherein the at least one feature comprises a specific trim selected from a plurality of trims for the make and model of the vehicle;
wherein the baseline price estimation model is trained based on the historical pricing data for the vehicles with the make, model and specific trim; and
wherein the price bin estimation model trained is based on the historical pricing data for the vehicles with the make, model and specific trim sold in the range based on the price bin.

14. The method of claim 12, wherein the price bin has a lower price limit and an upper price limit;
wherein the initial price estimate is greater than or equal to the lower price limit and less than or equal to the upper price limit; and
wherein the range based on the price bin is between the lower price limit and the upper price limit.

15. The method of claim 12, wherein the price bin has a price bin range defined by a lower price limit and an upper price limit;
wherein the initial price estimate is greater than or equal to the lower price limit and less than or equal to the upper price limit; and
wherein the range based on the price bin is from a lower range limit to an upper range limit, the lower range limit being less that the lower price limit by a predetermined percentage of the price bin range, the upper range limit being greater that the upper price limit by the predetermined percentage of the price bin range.

16. The method of claim 12, further comprising clustering the historical pricing data for vehicles with the make and model sold in the price range into a plurality of clusters;
generating at least a first price bin and a second price bin from the plurality of clusters; and
wherein the price bin is selected from the first price bin and the second price bin.

17. The method of claim 16, wherein clustering the historical pricing data for vehicles with the make and model sold in the price range is based on at least one of density or distribution of the historical pricing data.

18. The method of claim 17, wherein clustering is dynamically performed responsive to receiving an indication that the vehicle is subject to auction.

19. The method of claim 16, wherein clustering the historical pricing data for vehicles with the make and model sold in the price range is based on at least one of density or distribution of the historical pricing data.

20. The method of claim 19, wherein the baseline price estimation model is first generated;
wherein the baseline price estimation model is then used to determine the initial price estimate;
wherein the clustering is performed to determine one or more price bins;
wherein the price bin is selected from the clustering that includes the initial price estimate;
wherein, responsive to selecting the price bin, the price bin estimation model is generated for the selected price bin; and
wherein, after generating the price bin estimation model, the price bin estimation model is used to output the price bin estimate.

21. The method of claim 19, wherein the baseline price estimation model is first generated;
wherein the clustering is performed to determine a plurality of price bins;
wherein respective price bin estimation models are generated for each of the plurality of price bins;
wherein the baseline price estimation model is then used to determine the initial price estimate;
wherein the price bin is selected from the clustering that includes the initial price estimate;
wherein, responsive to selecting the price bin, the price bin estimation model that was previously generated is accessed for the selected price bin; and
wherein, after accessing the price bin estimation model, the price bin estimation model is used to output the price bin estimate.
